(19) United States
(12) Patent Application Publication
(10) Pub. No.: US 2004/0263545 A1
(43) Pub. Date: Dec. 30, 2004

(54) Inkjet recording system and inkjet recording method

(75) Inventors: Takahiro Esaki, Fukuoka (JP); Hidetoshi Matsuo, Saga (JP); Seiji Nakagawa, Fukuoka (JP); Takamichi Oyama, Fukuoka (JP); Hiroshi Hattori, Fukuoka (JP); Yutaka Miyazono, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd, Osaka (JP)

(21) Appl. No.: 10/878,203

(22) Filed: Jun. 29, 2004

(30) Foreign Application Priority Data
Jun. 30, 2003 (JP) 2003-187478
Sep. 9, 2003 (JP) 2003-316481

(51) Int. Cl. B41J 1/00

(52) U.S. Cl. 347/5; 358/1.2

(57) ABSTRACT

A recording direction setting section successively sets recording directions of an image. A recording data generating section generates data for recording the image from the recording direction set by the recording direction setting section. A recording data analyzing section analyzes the operation of a line head performed when recording is carried out in accordance with the data generated by the recording data generating section. A recording direction determining section determines a recording direction so as to minimize the discharging frequency of a nozzle with the largest discharging frequency among a plurality of nozzles of the line head.

### CROSS REFERENCE TO RELATED APPLICATIONS

This Non-provisional application claims priority under 35 U.S.C. § 119(a) on Patent Application Nos. 2003-187478 and 2003-316481 filed in Japan on Jun. 30 and Sep. 9, 2003, respectively the entire contents of which are hereby incorporated by reference.

### BACKGROUND OF THE INVENTION

The present invention relates to an inkjet recording system equipped with an inkjet recording head, and an inkjet recording method.

In mass production of, for example, read-only CD-ROM disks and DVD-ROM disks, images such as letters and graphics have conventionally been repeatedly and continuously printed on the faces of these disks. Examples of the images are titles, names of manufacturers and distributors, and logotypes.

Also, in order to issue a large number of vouchers in a short period of time, border lines and letters included as the contents of the vouchers are continuously printed on recording paper.

Conventionally, the aforementioned kind of printing has been performed by using a screen printer or an offset printer dedicated to this purpose (see, for example, Japanese Laid-Open Patent Publication No. 2002-230841).

FIG. 49 shows a fabrication flow for the fabrication of a DVD-ROM disk having two layers on each face. First, in a substrate molding step 151, a substrate 105 on which pits (an information recording region) are formed is fabricated through injection molding of a substrate material such as polycarbonate by using a stamper formed in accordance with information to be recorded. In a next reflection film forming step 152, aluminum is deposited on a pit face opposite to a light incident face of the substrate 105, so as to form a reflection film for reflecting a laser beam. Then, in an adhesion step 153, two substrates 105 having pits respectively corresponding to different data of two layers are adhered to each other with an adhesive applied by spin coating or the like and the adhesive is cured through UV irradiation. In an underlying layer forming step 154, an ink used for forming an underlying layer is applied on the face opposite to the light incident face by screen printing or the like, and the ink is cured through the UV irradiation. Then, in a printing step 155, a label and the like are printed on the face of the disk by screen printing or offset printing and are UV cured. In this manner, the DVD-ROM disk is fabricated.

The screen printing or the offset printing, however, requires considerable time and cost for creating a printing block and adjusting colors. Also, in the case where a title or the like to be printed is to be changed, the printer should be once stopped and the printing setting should be reset from the beginning. Therefore, the fabrication of the DVD-ROM cannot help stopping for a long period of time.

Alternatively, with respect to the printing of vouchers, ruled lines and border lines included in the contents of the vouchers are common to all the vouchers but the names of clients and the like to be printed in the respective vouchers are different. In other words, most of the printing contents are common to all the vouchers but merely part of the contents is different among the vouchers. Therefore, when the screen printing or the offset printing is employed, merely the printing contents common to all the vouchers are printed, and a part of the printing content different among the vouchers should be printed by using another printing means.

As a countermeasure, an inkjet recording apparatus can be comparatively inexpensively fabricated, and the printing setting can be easily and rapidly reset by changing image data to be supplied to an inkjet recording head included in the inkjet recording apparatus. Also, merely a part of the printing contents can be comparatively easily changed.

In the case where one and the same image is recorded on a large scale by using the inkjet recording apparatus, the following problems occur:

The lifetime of the inkjet recording head depends upon the numbers of times of discharging an ink (hereinafter referred to as the discharging frequencies) of nozzles, and hence, when the discharging frequency exceeds a given value, the recording head cannot exhibit desired performance. The discharging frequency of each nozzle of the recording head depends upon the contents of an image to be recorded, and hence, in one recording head, some nozzles have large discharging frequencies and the other nozzles have small discharging frequencies. Therefore, in recording the same image on a large scale, a large difference can be easily caused in the discharging frequency among the nozzles.

For example, it is assumed that a line head 110 having a plurality of nozzles 111 vertically arranged is used for recording a title, a distributor, disk specifications and a subtitle respectively in regions 101, 102, 103 and 104 on a disk 100 as shown in FIG. 50. In this case, the discharging frequency of each nozzle 112 used for discharging the ink onto the region 101 is K times, that of each nozzle 113 used for discharging the ink onto the regions 102 and 103 is 2K times, and that of each nozzle 114 used for discharging the ink onto the region 104 is K times. As a result, there is large dispersion in the discharging frequency among the nozzles.

Alternatively, it is assumed that a line head 110 having a plurality of nozzles 111 vertically arranged is used for recording a letter “A” and a border line 115 surrounding the letter on recording paper 106 as shown in FIG. 51. In this case, as shown in FIG. 51, although the nozzle 111a used for recording the border line 115 extending along the lateral direction discharges the ink as frequently as 46 times, most of the other nozzles discharge the ink 4 times or less. Thus, there is large dispersion in the discharging frequency among the nozzles.

When the lifetime of any nozzle of a line head is over, the line head cannot exhibit the initial performance as a whole, and hence, the lifetime of the line head is over. Therefore, when the lifetime of any nozzle is over, it is necessary to once stop the fabrication of DVD-ROMs or the creation of vouchers for exchanging the line head. In the setting of a line head, however, the positioning should be adjusted with accuracy of the order of micrometer. Therefore, the exchange of the line head requires a lot of time and labor. Accordingly, in order to improve efficiency in the fabrication of DVD-ROMs or the creation of vouchers, it is desired to elongate the lifetime of the line head as much as possible so as to reduce the number of times of exchanging the line head.

For example, in the case shown in FIG. 50, assuming that the discharging frequency corresponding to the lifetime of each nozzle (hereinafter referred to as the lifetime frequency) is Z times, the lifetime of the nozzle 113 is over when the recording is performed on Z/2K disks. However, the nozzles 112 and 114 have discharged the ink merely a half time of their lifetime frequencies at this point, and moreover, the discharging frequencies of the other nozzles are zero.

When there is large dispersion in the discharging frequency among the nozzles in this manner, time elapsed until the discharging frequency of a specific nozzle reaches its lifetime frequency is short. Therefore, the number of times of exchanging the line head is increased, and hence, it may take a long period of time to complete the fabrication of DVD-ROMs or the creation of vouchers. Also, even when the discharging frequencies of a large number of nozzles are small as compared with their lifetime frequencies, the whole line head should be discarded, and therefore, it is difficult to efficiently use the line head.

### SUMMARY OF THE INVENTION

The present invention was devised in consideration of the aforementioned conventional problems, and an object of the invention is, in the case where the same image or substantially the same image is recorded plural times by using an inkjet recording head, elongating the lifetime of the recording head and improving the efficiency of use of the recording head.

The inkjet recording system of this invention includes an inkjet recording head having a plurality of nozzles arranged along a first direction; moving means for moving the recording head and a recording medium relatively to each other along a second direction not parallel to the first direction; image data conversion means for converting image data for recording a desired image from a given recording direction in such a manner that the recording direction of the image is changed by rotating the image; and control means for accepting the converted image data obtained by the image data conversion means and controlling the recording head and the moving means for recording the image on the recording medium with the second direction set as a changed recording direction.

In the aforementioned recording system, the recording direction of an image can be changed. Therefore, even when the same image is recorded on a large scale, the lifetime of the recording head can be elongated by performing the recording from a recording direction for elongating the lifetime of the recording head. Also, the recording head can be efficiently used by performing the recording from a recording direction for reducing the dispersion of discharging frequencies of the nozzles or from a recording direction for increasing the number of used nozzles. Since the use frequencies of nozzles used in the recording can be more averaged, for example, a nozzle that discharges an ink merely once in recording the image before changing the recording direction is made to discharge the ink a plurality of times, and thus, the time intervals of the discharging of the nozzles are more averaged. Although the viscosity of an ink is increased as the time interval is large, a difference in the viscosity among the inks contained in the respective nozzles in the discharging can be reduced, resulting in stabilizing the discharging as a whole.

Alternatively, the inkjet recording system of this invention includes an inkjet recording head having a plurality of nozzles arranged along a first direction; moving means for moving the recording head and a recording medium relatively to each other along a second direction not parallel to the first direction in a recording operation; control means for accepting image data for recording an image by allowing the nozzles of the recording head to discharge an ink and for controlling the recording head and the moving section for recording the image on the recording medium; and image data conversion means for converting the image data in such a manner that nozzles used for recording the image are shifted along the first direction in the recording head, and the control means accepts the converted image data and controls the recording head for recording the image with nozzles used for the recording shifted along the first direction.

In the aforementioned recording system, the image data conversion means converts the image data and the recording head can record the image shifted along the first direction corresponding to the direction for arranging at least the nozzles on the basis of the converted image data. Accordingly, in the case where the same or substantially the same (hereinafter simply referred to as the same) image is recorded on a large scale, the combination of nozzles used for recording the image can be appropriately changed by appropriately shifting the image. As a result, the use frequencies of the nozzles can be more averaged, and the dispersion of the discharging frequencies among the nozzles can be reduced. Accordingly, the lifetime of the recording head can be elongated and the recording head can be efficiently used.

Other objects of the invention will become apparent to those skilled in the art from the following detailed description taken in connection with the accompanying drawings.

### BRIEF DESCRIPTION OF THE DRAWINGS

FIG. 1 is a diagram for showing the architecture of a recording system according to any of Embodiments 1 through 3;

FIG. 2 is a perspective view of a recording apparatus according to any of Embodiments 1 through 3;

FIG. 3 is a schematic plan view of a line head;

FIG. 4 is a plan view of a unit head;

FIG. 5 is a schematic diagram for showing the positional relationship in relative movement between a line head and a disk;

FIG. 6 is a block diagram of a control system of the recording system according to any of Embodiments 1 through 3;

FIG. 7 is a schematic diagram for explaining movement of a disk;

FIG. 8 is a block diagram of recording direction adjusting means;

FIG. 9 is a flowchart of a setting method for a recording direction;

FIG. 10 is a diagram for showing an image and discharging frequencies of respective nozzles necessary for recording the image in the case where a rotation angle θ is 0 degree in Embodiment 1;

FIG. 11 is a diagram for showing an image and discharging frequencies of respective nozzles necessary for recording the image in the case where the rotation angle θ is 30 degrees in Embodiment 1;

FIG. 12 is a diagram for showing an image and discharging frequencies of respective nozzles necessary for recording the image in the case where the rotation angle θ is 60 degrees in Embodiment 1;

FIG. 13 is a diagram for showing an image and discharging frequencies of respective nozzles necessary for recording the image in the case where the rotation angle θ is 90 degrees in Embodiment 1;

FIG. 14 is a diagram for showing an image and discharging frequencies of respective nozzles necessary for recording the image in the case where the rotation angle θ is 120 degrees in Embodiment 1;

FIG. 15 is a diagram for showing an image and discharging frequencies of respective nozzles necessary for recording the image in the case where the rotation angle θ is 150 degrees in Embodiment 1;

FIG. 16 is an explanatory diagram of a tray transferring operation performed in using a tray for carrying one disk;

FIG. 17 is an explanatory diagram of a tray transferring operation performed in using a tray for carrying two disks;

FIG. 18 is a diagram for showing a complex image and discharging frequencies of respective nozzles necessary for recording the image in a comparative example of Embodiment 2;

FIG. 19 is a diagram for showing a complex image and discharging frequencies of respective nozzles necessary for recording the image in another comparative example of Embodiment 2;

FIG. 20 is a diagram for showing a complex image and discharging frequencies of respective nozzles necessary for recording the image in Embodiment 2;

FIG. 21 is a block diagram of an imaging device according to Embodiment 3;

FIG. 22 is a diagram for showing an image and discharging frequencies of respective nozzles necessary for recording the image in the case where a rotation angle θ is 0 degree in Embodiment 3;

FIG. 23 is a diagram for showing an image and discharging frequencies of respective nozzles necessary for recording the image in the case where the rotation angle θ is 30 degrees in Embodiment 3;

FIG. 24 is a diagram for showing an image and discharging frequencies of respective nozzles necessary for recording the image in the case where the rotation angle θ is 60 degrees in Embodiment 3;

FIG. 25 is a diagram for showing an image and discharging frequencies of respective nozzles necessary for recording the image in the case where the rotation angle θ is 90 degrees in Embodiment 3;

FIG. 26 is a diagram for showing an image and discharging frequencies of respective nozzles necessary for recording the image in the case where the rotation angle θ is 120 degrees in Embodiment 3;

FIG. 27 is a diagram for showing an image and discharging frequencies of respective nozzles necessary for recording the image in the case where the rotation angle θ is 150 degrees in Embodiment 3;

FIG. 28 is a diagram for showing an image and discharging frequencies of respective nozzles necessary for recording the image in the case where the rotation angle θ is 180 degrees in Embodiment 3;

FIG. 29 is a diagram for showing an image and discharging frequencies of respective nozzles necessary for recording the image in the case where the rotation angle θ is 210 degrees in Embodiment 3;

FIG. 30 is a diagram for showing an image and discharging frequencies of respective nozzles necessary for recording the image in the case where the rotation angle θ is 240 degrees in Embodiment 3;

FIG. 31 is a diagram for showing an image and discharging frequencies of respective nozzles necessary for recording the image in the case where the rotation angle θ is 270 degrees in Embodiment 3;

FIG. 32 is a diagram for showing an image and discharging frequencies of respective nozzles necessary for recording the image in the case where the rotation angle θ is 300 degrees in Embodiment 3;

FIG. 33 is a diagram for showing an image and discharging frequencies of respective nozzles necessary for recording the image in the case where the rotation angle θ is 330 degrees in Embodiment 3;

FIG. 34 is a diagram for showing average discharging frequencies of the respective nozzles in Embodiment 3;

FIG. 35 is a perspective view of a recording device according to Embodiment 4 or 5;

FIG. 36 is a block diagram of a control system of a recording system according to Embodiment 4 or 5;

FIG. 37 is a diagram of an image and a graph for showing discharging frequencies of respective nozzles necessary for recording the image;

FIG. 38 is a diagram for showing the relative position of a line head against a roll sheet;

FIG. 39 is a diagram for showing the relative position of the roll sheet against the line head;

FIG. 40 is a diagram for showing an image, the position of a line head and average discharging frequencies of respective nozzles in recording the image in exemplified recording of Embodiment 4;

FIG. 41 is a diagram for showing an image, the position of the line head and average discharging frequencies of respective nozzles in recording the image in another exemplified recording of Embodiment 4;

FIG. 42 is a diagram for explaining conversion of image data according to Embodiment 5;

FIG. 43 is a flowchart of a recording operation according to Embodiment 5;

FIG. 44 is a diagram for showing an image, the position of a line head and average discharging frequencies of respective nozzles in recording the image in exemplified recording in which the image is rotated;

FIG. 45 is a graph for showing average discharging frequencies of respective nozzles in the recording operation of Embodiment 5;

FIG. 46 is a plan view of a modified recording head;

FIG. 47 is a plan view of another modified recording head;

FIG. 48 is a schematic diagram for showing the positional relationship between a line head and a roll sheet;

FIG. 49 is a diagram for showing fabrication of a DVD-ROM disk;

FIG. 50 is diagram for showing an image to be recorded on a disk and discharging frequencies of respective nozzles necessary for recording the image; and

FIG. 51 is a diagram for showing an image and discharging frequencies of nozzles necessary for recording the image.

### DETAILED DESCRIPTION OF THE INVENTION

Now, preferred embodiments of the invention will be described with reference to the accompanying drawings.

### EMBODIMENT 1

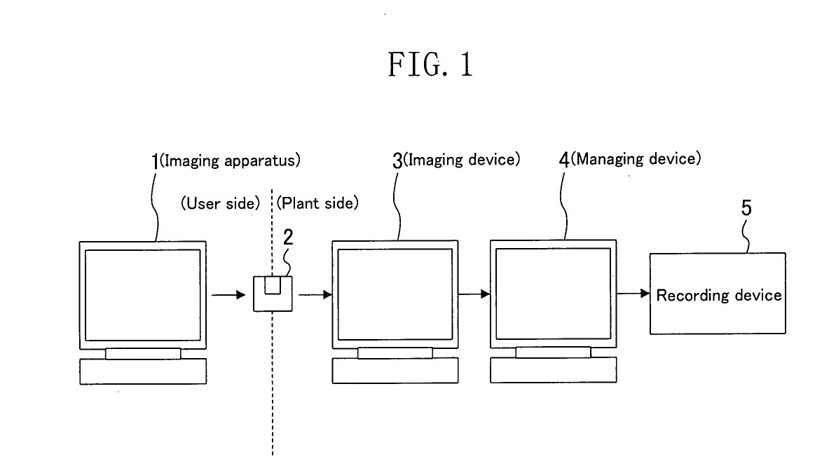

First, referring to FIG. 1, procedures for recording an image on the face of a disk (such as a DVD-ROM disk) will be described. It is noted that an image herein includes one or more of a letter, a line, a symbol, a picture, a photo and the like.

In general, the image to be recorded on the face of the disk is created by an image creator such as a designer by using an imaging apparatus 1 such as a personal computer. The image created by the image creator is electronically converted into image information and sent to an imaging device 3 through an information recording medium (such as an MO) 2, or wired or wireless communication means. The imaging device 3 reads the image information and performs image processing in accordance with the resolution and the coloring characteristic of a recording device 5 so as to generate image data. The thus generated image data is sent to a managing device 4. The managing device 4 principally manages status information of respective devices used for the fabrication of the disk and the fabrication state. The managing device 4 transfers the image data received from the imaging device 3 to the recording device 5. The recording device 5 records the desired image on the face of the disk on the basis of the transferred image data.

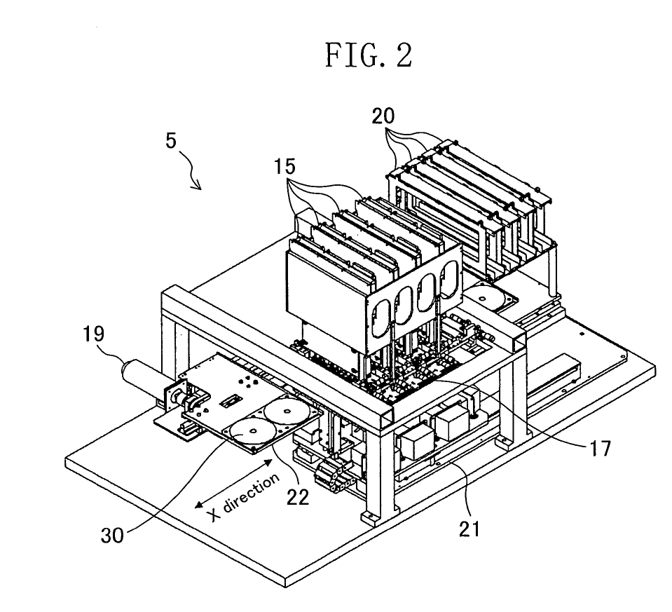

Next, referring to FIG. 2, the architecture of the recording device 5 will be described. The recording device 5 is an inkjet recording apparatus equipped with four inkjet line heads and forms a color image by combining inks of four colors of yellow (Y), cyan (C), magenta (M) and black (Bk). A head control unit 15 for controlling the line head, a head block 17, an ink tank 20 and a recovery system mechanism 21 are provided with respect to each of the colors. The recovery system mechanism 21 performs capping for preventing head nozzle faces from drying, cleaning of the head nozzle faces and the like.

The recording device 5 further includes a tray 22 for supporting a disk 30 serving as a recording target. Although not shown in the drawing, the tray 22 is provided with a fixing mechanism for adsorbing and fixing the disk 30. Furthermore, the recording device 5 includes an LF motor 19 serving as a driving mechanism for transferring the tray 22 along a predetermined direction (that is, an X direction in the drawing). Thus, the tray 22 is transferred by the LF motor 19, so as to move below the head block 17 along the X direction.

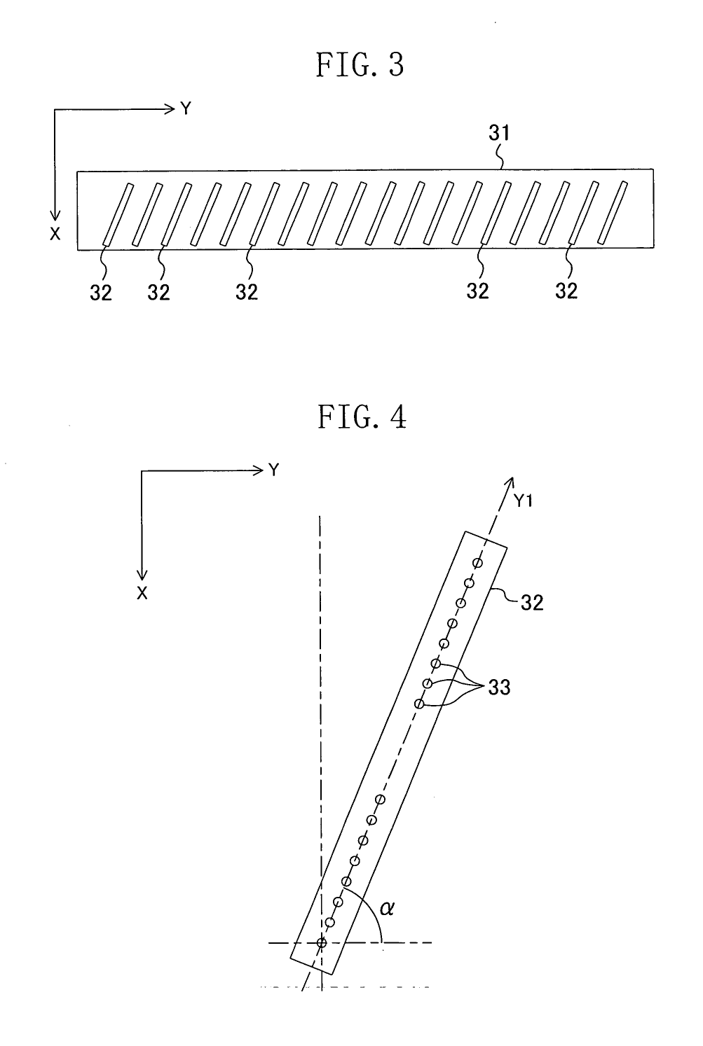

The line head 31 is not particularly specified in its shape and kind as far as it has a plurality of nozzles arranged along a given direction. In this embodiment, however, the structure of the recording head is devised for improving the resolution. Specifically, as shown in FIGS. 3 and 4, the line head 31 of each color is constructed by combining a plurality of unit heads 32 each having a plurality of linearly arranged nozzles 33. More specifically, in each line head 31, a plurality of unit heads 32 inclined against the X direction and parallel to one another are arranged along a Y direction perpendicular to the X direction. Owing to this structure, the density of the nozzles of each line head 31 is increased, so as to improve the resolution.

As shown in FIG. 4, each unit head 32 includes 200 nozzles 33 arranged at a pitch of 133.9 μm. The nozzles 33 are linearly arranged so that the linear arrangement direction Y1 can be inclined against the Y direction by a given angle α. In this embodiment, the angle α is set to 71.6 degrees. Thus, each line head 31 has a length (along the Y direction) of 152.3 mm, has 3600 nozzles in total, and has resolution along the X direction of 200 dpi (with a pitch of 127 μm) and resolution along the Y direction of 600 dpi (with a pitch of 42.33 μm).

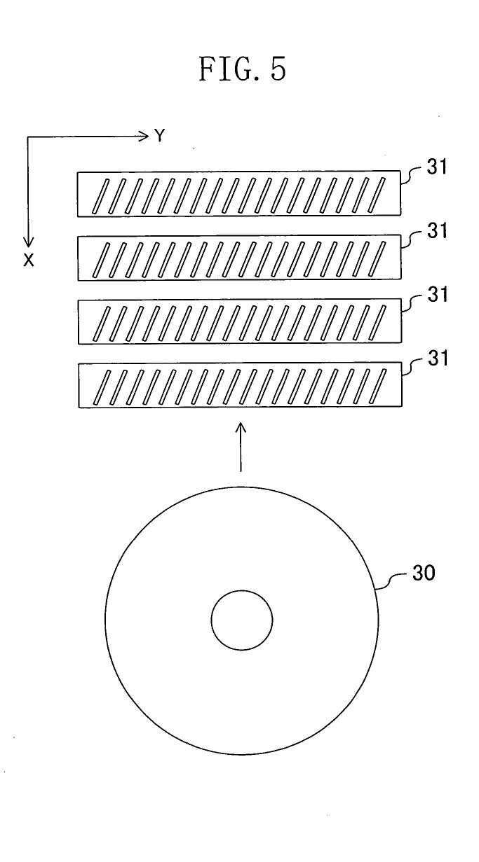

As shown in FIG. 5, the line heads 31 of the respective colors are disposed to extend along the Y direction and to be adjacent to one another along the X direction. In other words, the line heads 31 are disposed to extend along a direction perpendicular to a relative moving direction between the line heads 31 and the disk 30.

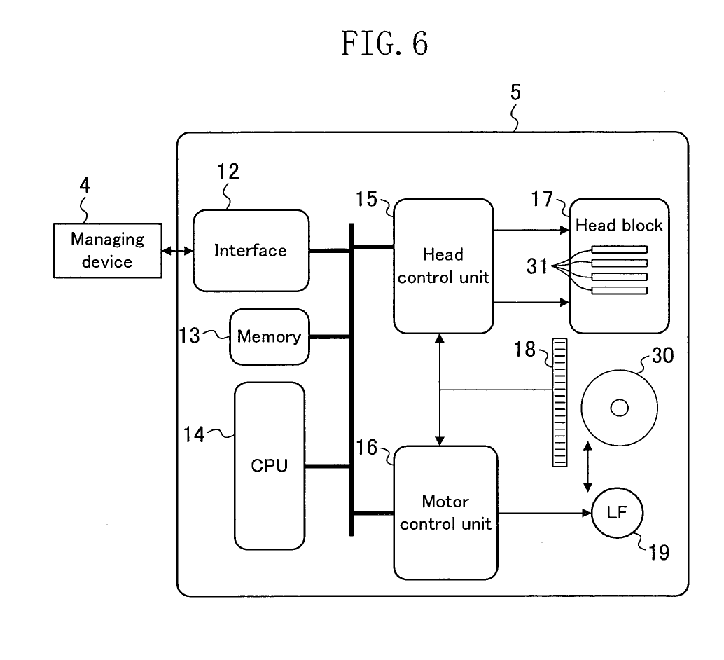

FIG. 6 is a block diagram of a control system of the recording system of this embodiment. As shown in FIG. 6, the recording device 5 includes an interface unit 12 for sending/receiving image data and various control commands to/from the managing device 4, a memory 13 for storing the image data and a control program, a CPU 14 for controlling the whole recording device 5, a head control unit 15 for controlling the respective line heads 31, a motor control unit 16 for controlling the LF motor 19, and an encoder sensor 18 for detecting the transferred position of the disk 30 and generating a pulse used as a reference in the control by the motor control unit 16 and the head control unit 15.

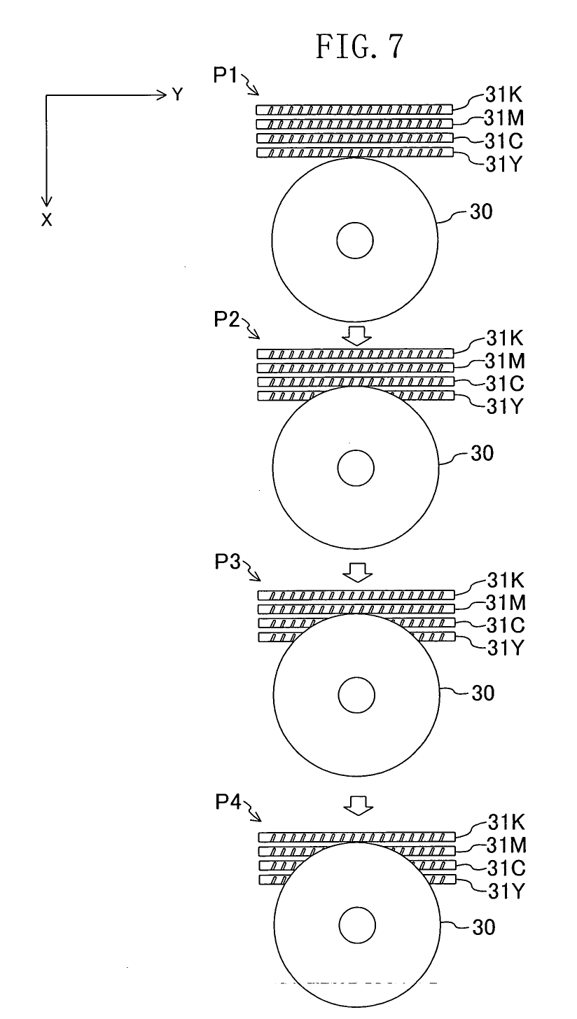

Next, the basic recording operation of the recording device 5 will be described with reference to FIGS. 6 and 7. First, a recording instruction signal including image data is sent from the managing device 4 to the recording device 5 through the interface unit 12. When the recording instruction signal is received, the CPU 14 stores the received image data in the memory 13, performs the image processing and processing for permutating data in accordance with the positions of the nozzles of the heads 31 as well as initialization processing for the head control unit 15 and the motor control unit 16.

As the initialization processing, for example, the capping for preventing the head nozzle faces from drying is cancelled, the head nozzle faces are cleaned, a reference voltage of an amplifier for supplying a head driving waveform is set, the reference origin of a recording medium transfer mechanism including the LF motor 19 is set, a control parameter is set and the tray 22 is moved to a recording start position. Also, as the initialization processing, prior to a recording operation, the inks may be forcedly discharged from the nozzles for refreshing the inks standing in the vicinity of the nozzle tips or actuators of the heads may be driven for meniscus vibrating the inks contained in the nozzles.

After completing such initialization processing, the motor control unit 16 drives the LF motor 19, so as to move the tray 22 along the X direction, and thus, the transfer of the disk 30 is started. As shown in FIG. 7, the disk 30 moves to reach the line head 31Y for discharging the yellow ink, the line head 31C for discharging the cyan ink, the line head 31M for discharging the magenta ink and the line head K for discharging the black ink in this order (see positions P1 through P4 of FIG. 7). During this movement, the inks of the respective colors are discharged from the line heads 31Y, 31C, 31M and 31K, resulting in recording the desired image on the face of the disk 30.

The aforementioned recording operation is carried out continuously on a plurality of disks 30. When the recording operation for a previously specified number of disks is completed, the recording device 5 performs the processing for cleaning the head nozzle faces, capping the head nozzle faces for preventing drying, and the like. Thereafter, the recording device 5 restores to the state prior to the start of the recording operation.

This is the basic operation of the recording device 5.

In this manner, the recording device 5 performs the recording operation on the face of the disk 30 from the given direction (the X direction). Accordingly, the image data includes not only the content of the image but also information about the direction for recording the image (i.e., the recording direction). However, the recording direction is not necessarily explicitly defined as an independent parameter in the image data but may be suggestively included in the image data. For example, with the up-and-down direction and the right and left direction previously defined in the recording device 5, the initial recording direction may be defined by making the up-and-down direction of the image to be recorded (that is, the up-and-down direction assumed by the image creator; for example, when the image is a figure picture, the head is in the upward direction and the feet are in the downward direction) accord with he up-and-down direction of the recording device 5.

In general, image data is created with an arbitrary direction assumed as the recording direction. In the recording system of this embodiment, however, the recording direction of the image is set in accordance with the content of the image in generating the image data in the imaging device 3. In other words, the imaging device 3 performs, on image data for recording a given image from a given recording direction, conversion processing so that the recording direction of the image can be changed by rotating the image.

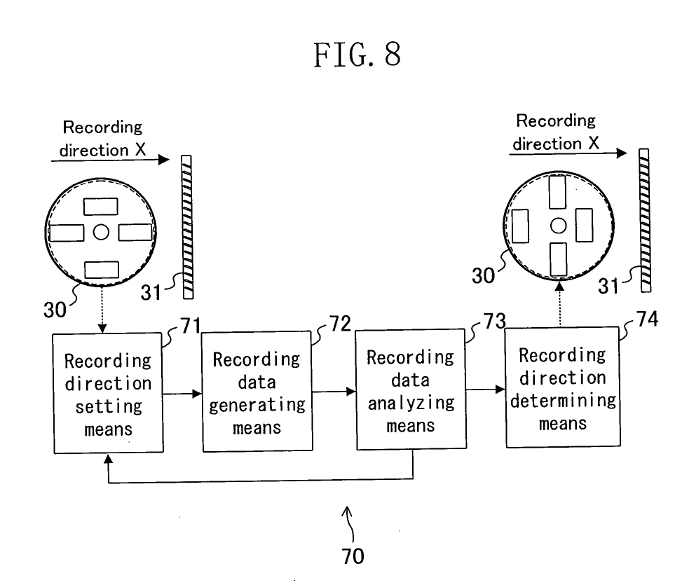

FIG. 8 is a block diagram of recording direction adjusting means 70 for setting the recording direction of an image. The recording direction adjusting means 70 is constructed in the imaging device 3 in the form of software (namely, on a computer program). However, it goes without saying that the recording direction adjusting means 70 may be constructed in the form of hardware. The recording direction adjusting means 70 includes recording direction setting means 71, recording data generating means 72, recording data analyzing means 73 and recording direction determining means 74.

In this embodiment, the recording direction adjusting means 70 selects an optimum or preferred recording direction from a plurality of recording directions on the basis of a predetermined evaluation criterion. The recording direction setting means 71 successively sets the plural recording directions. Herein, the recording direction is defined by rotating the image by a given angle. In other words, the recording direction can be changed merely by rotating the image without changing the content of the image. The recording data generating means 72 generates data for recording the image from the recording direction set by the recording direction setting means 71. The recording data analyzing means 73 receives the recording data from the recording data generating means 72, and analyzes the operation of the line heads 31 performed when the recording operation is carried out in accordance with the received recording data. Specifically, discharging frequencies of the respective nozzles of each line head 31 necessary for recording the image in accordance with the recording data are calculated, so as to perform given evaluation on the basis of the predetermined evaluation criterion. The evaluation result is sent to the recording direction determining means 74. The content of the evaluation will be described in detail later.

When the analysis by the recording data analyzing means 73 of one recording direction is completed, the recording direction setting means 71 sets another recording direction, and similar processing is performed on the basis of this recording direction in the recording data generating means 72 and the recording data analyzing means 73. As a result, the recording direction determining means 74 stores the evaluation results of the plural recording directions. Then, the recording direction determining means 74 selects one recording direction with the most preferable evaluation result from the plural recording directions, and determines the selected recording direction as an actually employed recording direction.

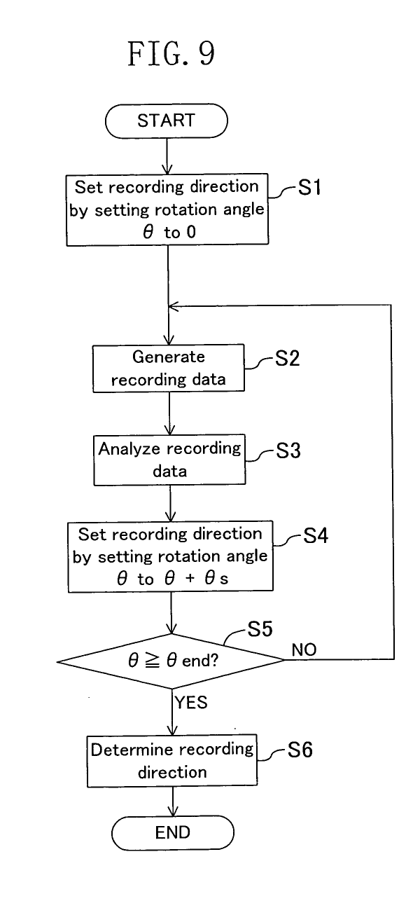

The method for setting a recording direction by the recording direction setting means 71 is not particularly specified. In this embodiment, the recording directions are respectively set by rotating the image by every predetermined constant angle θs. Specifically, as shown in FIG. 9, first in step S1, zero is first set as the initial value of the rotation angle θ. In other words, the original recording direction obtained before rotating 20 the image is directly set as the recording direction. Next, in step S2, the recording data generating means 72 generates recording data for recording the image from this recording direction. Subsequently, in step S3, the recording data analyzing means 73 analyzes the recording data. Specifically, the ink discharging operation of the line heads 31 performed when the image is recorded from the recording direction is analyzed.

Next, in step S4, the recording direction setting means 71 adds the given angle θs to the rotation angle θ, so as to set the resultant as a new rotation angle θ. In step S5, the rotation angle θ and a predetermined angle θend previously set as the reference of the end of the analysis are compared with each other, so as to determine whether or not the angle θ exceeds the angle θend. When the rotation angle θ is smaller than the given angle θend, the flow returns to step S2. Thus, the procedures of steps S2 through S5 are repeated. On the other hand, when the rotation angle θ exceeds the angle θend, the flow proceeds to step S6, so that the recording direction determining means 74 can determine the recording direction.

In this embodiment, the recording operation is continuously performed on a plurality of disks 30 in accordance with the recording direction determined in the aforementioned manner.

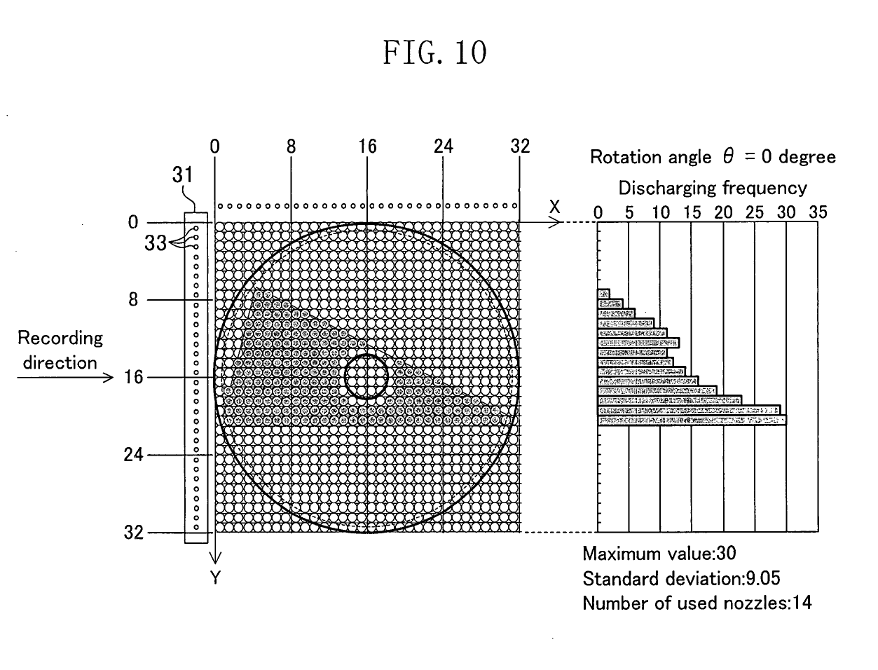

Next, the method for determining the recording direction will be specifically described by using a solid triangle as shown in FIG. 10 as an example of the image to be recorded. Herein, it is assumed for simplification that the number of nozzles of each line head 31 is 32 and that the ink is discharged from merely one line head 31 (namely, single-color recording is performed). Also, it is assumed that the line head 31 performs the ink discharging operation of 32 cycles for recording the image on one disk 30. In other words, the image is formed by a part of a set of 32×32 ink dots.

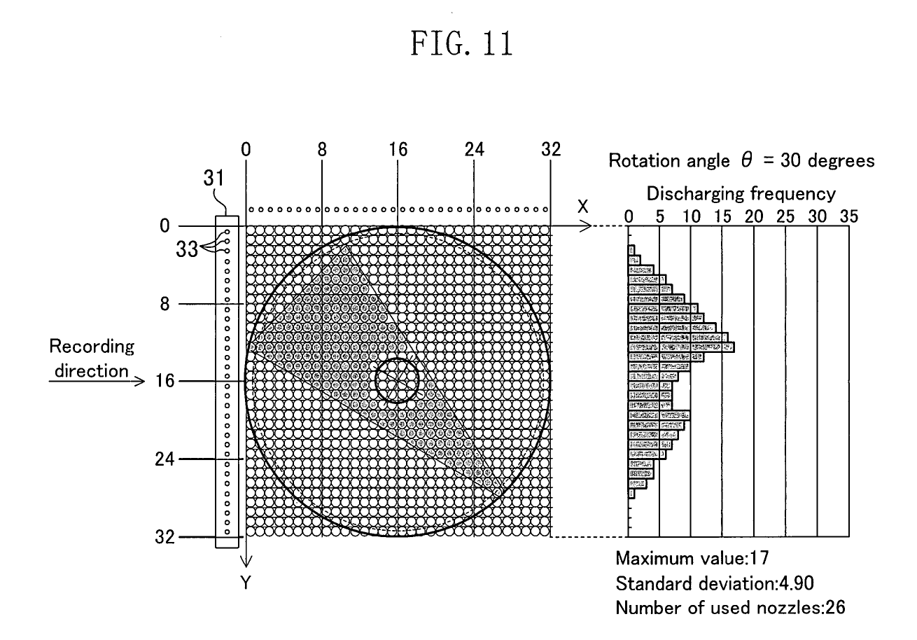

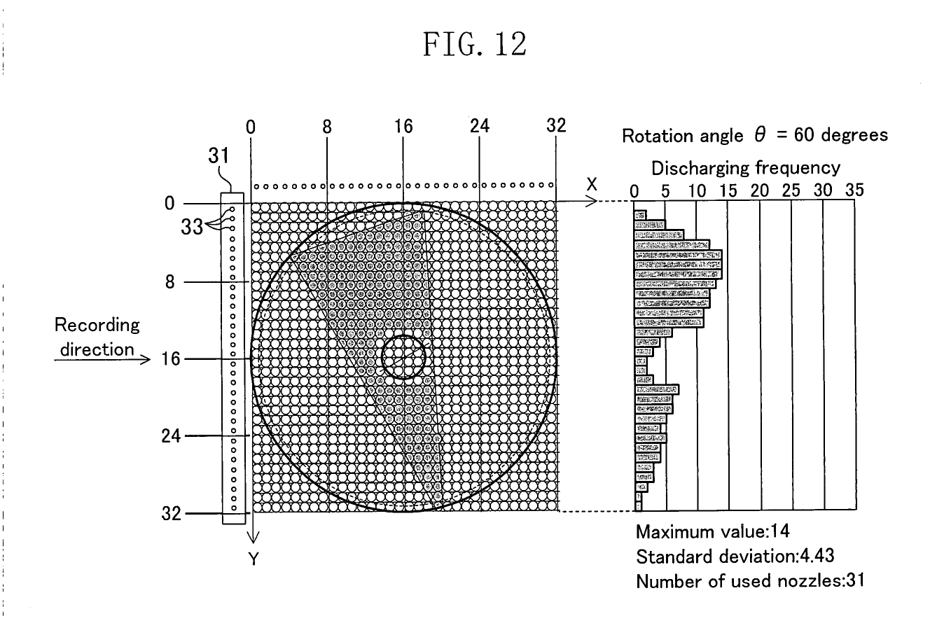

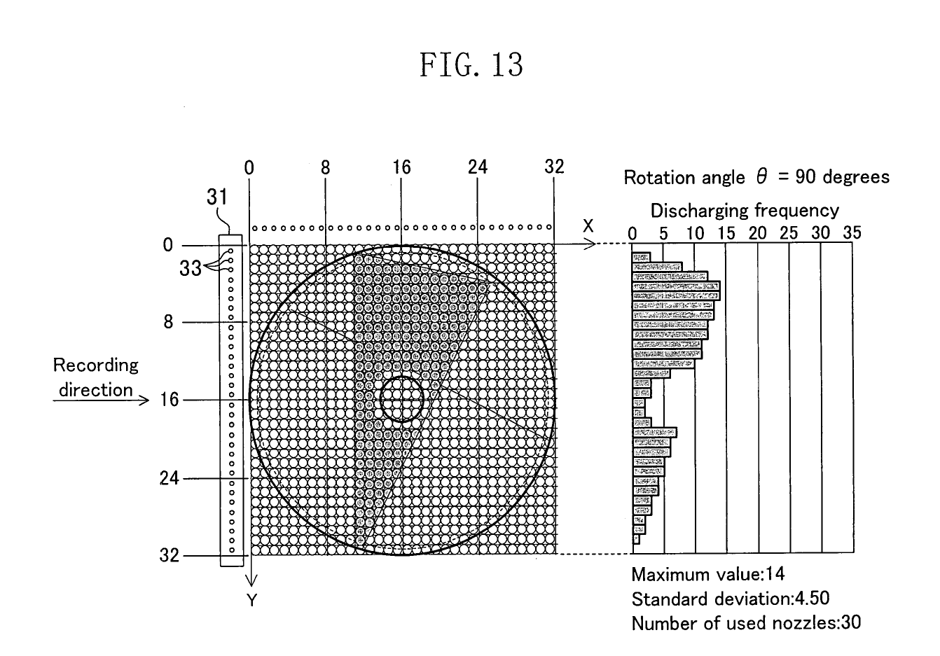

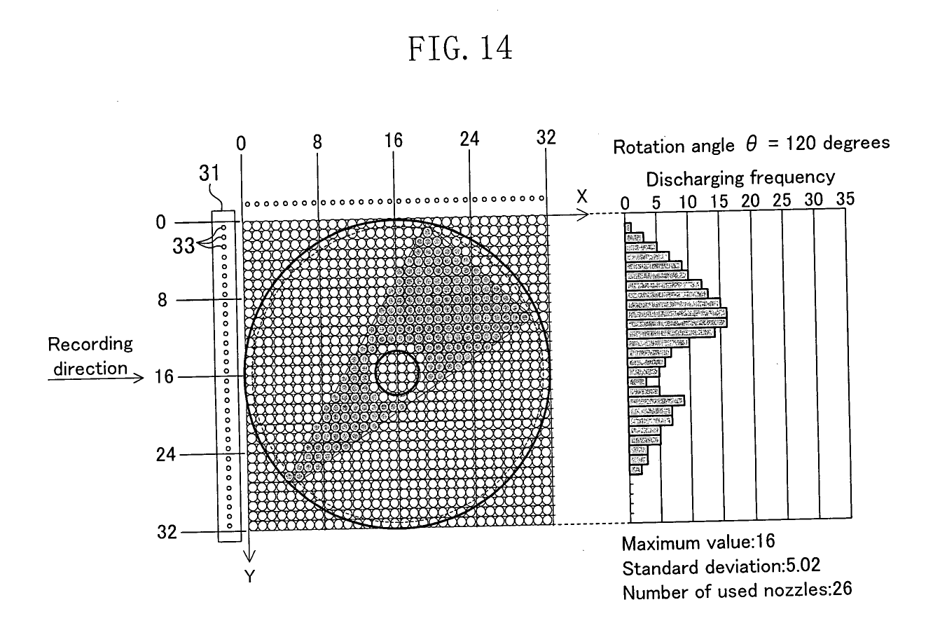

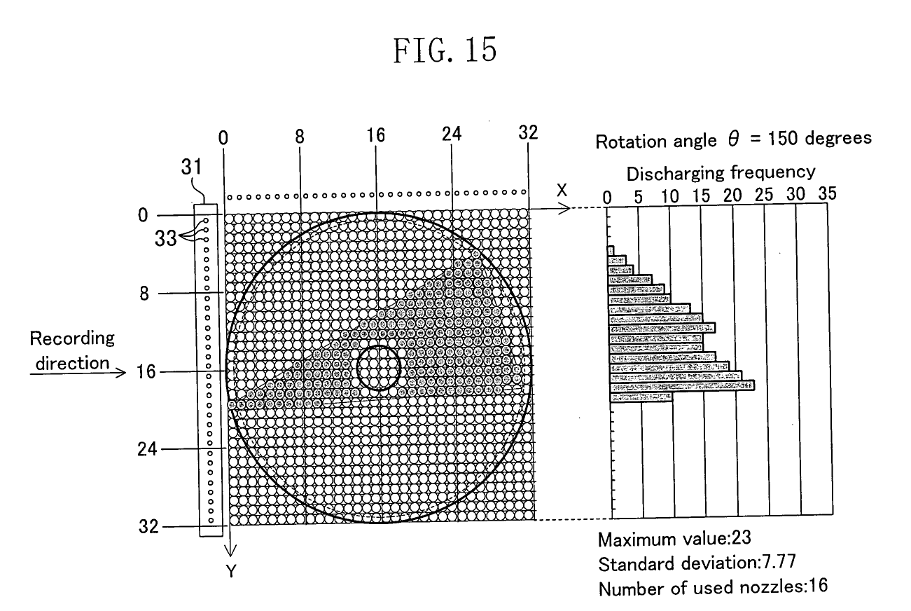

FIGS. 10, 11, 12, 13, 14 and 15 show the image contents and the discharging frequencies of the respective nozzles respectively obtained when the rotation angle θ is 0 degree, 30 degrees, 60 degrees, 90 degrees, 120 degrees and 150 degrees. In other words, the recording directions are herein set by respectively increasing the rotation angle θ by every 30 degrees (i.e., the rotation angle θs is 30 degrees). The analysis results obtained by employing the respective rotation angles (namely, the respective recording directions) are listed in Table 1 below. It is noted that the “maximum value” of Table 1 means the discharging frequency of a nozzle with the largest discharging frequency among all the nozzles, and that the “number of used nozzles” means the number of nozzles that discharge the ink at least once during the recording of the image. Also, the “standard deviation” means the dispersion of the discharging frequencies among the nozzles.

TABLE 1

| | | | Number of |
|---|---|---|---|
| Rotation angle θ | Maximum value | Standard deviation | used nozzles |
| 0 degree | 30 | 9.05 | 14 |
| 30 degrees | 17 | 4.90 | 26 |
| 60 degrees | 14 | 4.43 | 31 |
| 90 degrees | 14 | 4.50 | 30 |
| 120 degrees | 16 | 5.02 | 26 |
| 150 degrees | 23 | 7.77 | 16 |

As the evaluation criterion for determining the recording direction, any of various criteria may be employed. For example, the evaluation criterion may be that the discharging frequency of a nozzle with the largest discharging frequency (namely, the aforementioned maximum value) is the smallest (hereinafter referred to as the first criterion), that the standard deviation is the smallest (hereinafter referred to as the second criterion), or that the number of used nozzles is the largest (hereinafter referred to as the third criterion). Alternatively, the aforementioned criteria may be appropriately combined to obtain one criterion. For example, in the case where it is found as a result of the evaluation on the basis of the first criterion that a plurality of recording directions have the same evaluation result, the evaluation may be further performed successively on the basis of the second criterion and the third criterion in this order, so as to select one of the recording directions. When the exemplified image is subjected to such evaluation, the recording direction corresponding to the rotation angle θ of 60 degrees is selected.

When the rotation angle θ is 60 degrees, the maximum value is reduced from 30 to 14 as compared with the original recording direction (corresponding to the rotation angle θ of 0 degree). Accordingly, according to this embodiment, when the image is repeatedly recorded, the lifetime of the line head 31 is theoretically increased by 30/14 times, namely, 2.1 times. In other words, the lifetime of the line head 31 can be elongated by selecting the recording direction for attaining the smallest maximum value. Alternatively, the line head 31 can be efficiently used by selecting a recording direction for attaining the smallest standard deviation or a recording direction for attaining the largest number of used nozzles.

As described so far, according to this embodiment, the largest discharging frequency of the nozzles 33 of the line head 31 can be reduced, and therefore, the lifetime of the line head 31 can be elongated. Also, the dispersion of the discharging frequencies among the nozzles can be suppressed, and the number of used nozzles can be increased. Therefore, the nozzles 33 of the line head 31 can be used comparatively uniformly, and hence, early degradation of merely a part of the nozzles 33 can be prevented. As a result, the line head 31 can be efficiently used.

In general, the viscosity of an ink contained in a nozzle is increased as the time interval of ink discharging from the nozzle is large. However, in the line head 31 of this embodiment, the frequencies of the uses of the respective nozzles are more averaged, and hence, the time intervals of the ink discharging from the respective nozzles 33 are averaged. Accordingly, a difference in the viscosity of the inks contained in the respective nozzles 33 at the time of the ink discharging is reduced, so as to stabilize the ink discharging performance as a whole.

Modifications

The image data is converted in the imaging device 3 in the aforementioned embodiment but the image data may be converted in the managing device 4 or the recording device 5 instead of the imaging device 3. Also, the conversion of the image data is performed not necessarily in a plant for fabricating the disk but it may be performed outside the plant. Alternatively, the image creator may previously convert the image data in the imaging apparatus 1. Needless to say, a third party other than the image creator and the disk manufacturer may convert the image data.

The recording directions are set by every predetermined rotation angle θs in the aforementioned embodiment. However, the recording directions can be set by irregularly changing the rotation angle θ of the image. For example, a random number generator (not shown) may be provided, so as to irregularly change the rotation angle θ on the basis of a random number generated by the random number generator. The method for changing the rotation angle θ is not particularly specified.

As shown in FIG. 2, in the recording device 5, the tray 22 supports two disks 30 arranged along the X direction so as to simultaneously carry the two disks 30. However, the tray 22 may support and carry merely one disk 30. However, when the two disks 30 are simultaneously carried as in the recording device 5, the following effect can be attained:

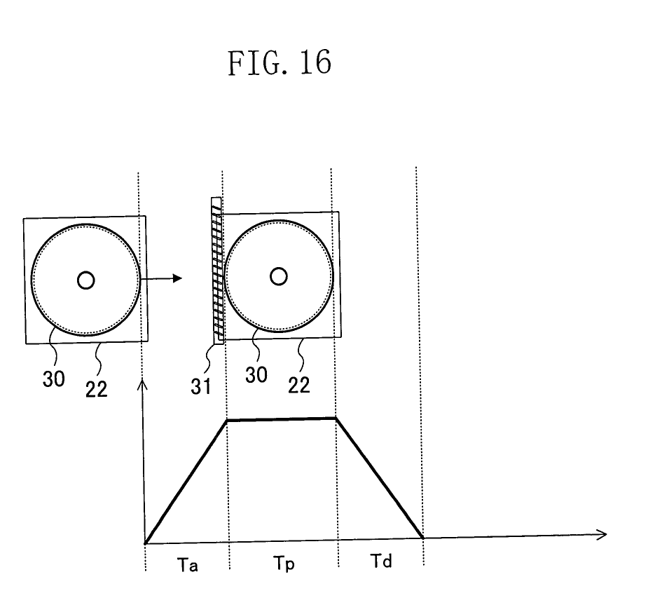

As shown in FIG. 16, when the recording operation is performed on the disks 30, it is necessary to accelerate the standing tray 22 to move below the line head 31, and thereafter, to discharge the ink from the line head 31 while transferring the tray 22 at a constant speed, and to decelerate the tray 22 to stop after completing the recording operation. Accordingly, a time T required for one recording operation corresponds to a sum of a time Ta when the tray 22 is accelerated, a time Tp when the tray 22 is transferred at a constant speed and a time Td when the tray 22 is decelerated. Therefore, although the inks are discharged from the line head 31 during the time Tp alone, the time required for one recording operation is longer by a sum of the times Ta and Td necessary for accelerating and decelerating the tray 22.

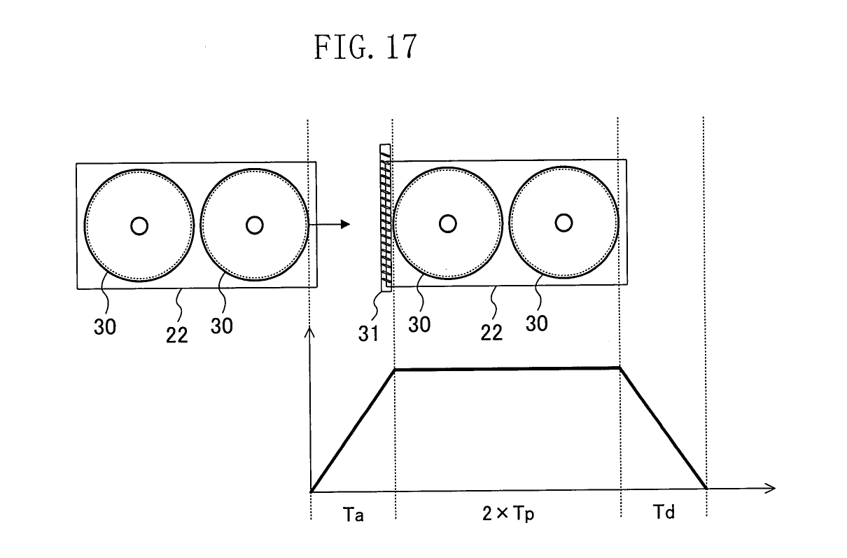

In contrast, the tray 22 carries the two disks 30 in this embodiment as shown in FIG. 17. Therefore, although time required for discharging the ink from the line head 31 is 2×Tp, the time necessary for accelerating and decelerating the tray 22 remains to be Ta+Tb. Accordingly, time required for the recording operation for each disk is (Ta+2Tp+Td)/2, which is shorter than the time required for performing the recording operation on every disk. Accordingly, time necessary for the recording processing can be shortened.

The image data to be supplied to the recording device 5 may be created with respect to each image or may be created as data corresponding to a complex image including two images. Specifically, the image data can be created by regarding, as an image to be recorded by the line head 31 in one recording operation, a complex image in which the same images are repeatedly arranged along the direction for transferring the tray 22 (the X direction) and by regarding the two disks 30 as one recording target. In other words, the image data can be created with respect to every tray 22 carrying the two disks 30.

### EMBODIMENT 2

In Embodiment 2, image data is recorded on two disks in one recording operation and the recording direction for the image data is different between the first disk and the second disk. Specifically, in a complex image in which two images identical to each other are repeatedly arranged along the transferring direction of a tray 22 (i.e., the X direction), one or both of the images are rotated, so that the recording direction of one image can be different from that of the other image.

Now, the conversion of the image and the recording operation of Embodiment 2 will be described by using, as an example, a complex image in which two identical images the same as that described in Embodiment 1 (i.e., the solid triangle) are arranged along the X direction.

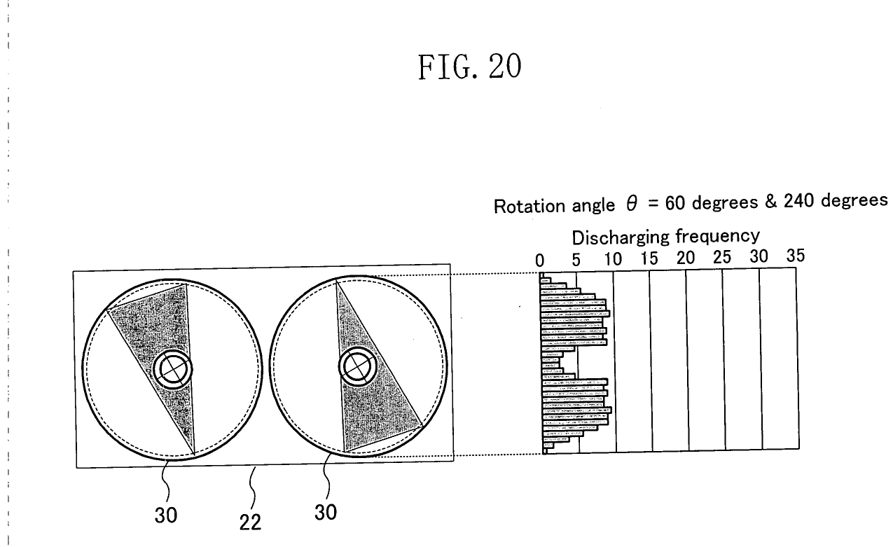

In this example, one image included in the complex image is subjected to the optimization processing similar to that described in Embodiment 1 (see FIG. 9). Specifically, the first image is rotated by the given angle θ in accordance with the predetermined evaluation criterion. Next, the second image is rotated to a state obtained by making the first image a half turn. In other words, the second image is rotated by an angle θ′ obtained by adding 180 degrees to the given angle θ (i.e., θ′=θ+180). Then, an image in which the first and second images thus rotated respectively by the angles θ and θ′ are arranged along the X direction is generated as a new complex image (see FIG. 20).

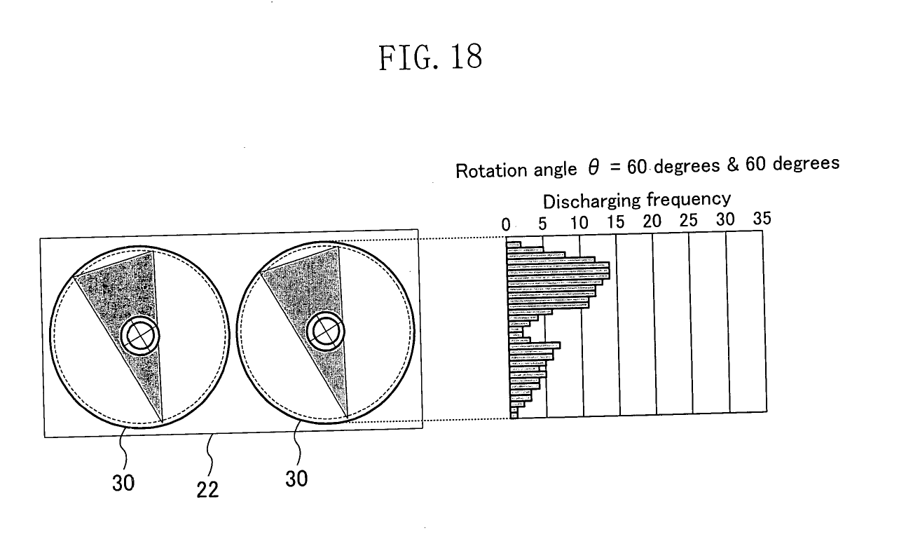

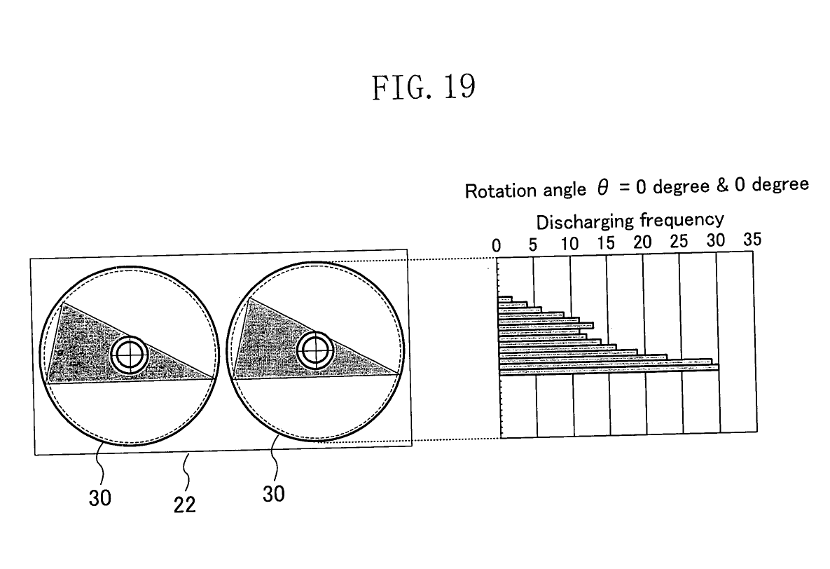

In recording the complex image in which the aforementioned images are repeatedly arranged along the transferring direction of the tray 22 (i.e., the X direction), when the images are not rotated, the maximum value of the discharging frequencies of a line head 31 is large as shown in FIG. 19. Also, the dispersion of the discharging frequencies among the nozzles is large and the number of used nozzles is small. In contrast, when both the images are rotated in the same manner as in described in Embodiment 1, the maximum value of the discharging frequencies is small as shown in FIG. 18. Also, the dispersion of the discharging frequencies among the nozzles is reduced and the number of used nozzles is increased.

In this embodiment, however, the recording directions of the two images are different from each other, and therefore, the maximum value of the discharging frequencies is 9.5, the standard deviation is 3.1 and the number of used nozzles is 31 as shown in FIG. 20. Thus, the maximum value of the discharging frequencies is further reduced, and the dispersion of the discharging frequencies among the nozzles is further reduced. Since the maximum value of the discharging frequencies is 9.5, the lifetime of the line head 31 is theoretically increased by 30/9.5 times, that is, 3.2 times.

Accordingly, according to this embodiment, since the same images included in the complex image are formed by using different nozzles 33, the lifetime of the line head 31 can be further elongated. Furthermore, the discharging dispersion among the nozzles can be further reduced, so as to more efficiently use the line head 31.

Moreover, since the data is created with respect to the complex image including the two images and the recording operation is performed on two disks 30 in a batch, the time necessary for the recording operation is shorter than that necessary when the recording operation is performed on every disk as described in Embodiment 1. Accordingly, the recording processing can be shortened.

The setting of the rotation angles of the respective images is not limited to that described above, and the rotation angles may be set by any of various methods. As the evaluation criterion for selecting the complex image, any of various criteria may be employed.

For example, the discharging frequencies necessary for the respective nozzles of the recording head may be calculated with respect to each complex image, so as to select a complex image for attaining the smallest discharging frequency of a nozzle with the maximum discharging frequency.

Alternatively, the discharging frequencies necessary for the respective nozzles of the recording head may be calculated with respect to each complex image, so as to select a complex image for attaining the smallest dispersion of the discharging frequencies of the nozzles.

Alternatively, the discharging frequencies necessary for the respective nozzles of the recording head may be calculated with respect to each complex image, so as to select a complex image for attaining the largest number of used nozzles.

It is noted that the number of images included in one complex image is not limited to two. The complex image may include N (wherein N is a natural number of 2 or more) images. The tray 22 may support and carry N disks 30. In this case, the complex image may be converted so that the N images included in the complex image can be respectively rotated by every 360°/N.

### EMBODIMENT 3

In Embodiment 1, the recording direction is determined by previously rotating an image, and the image is recorded from the determined recording direction over the whole sequential recording operation. In contrast, in Embodiment 3, image data is converted in such a manner that a desired image is rotated in the middle of the sequential recording operation, so as to appropriately change the recording direction of the image during the recording operation.

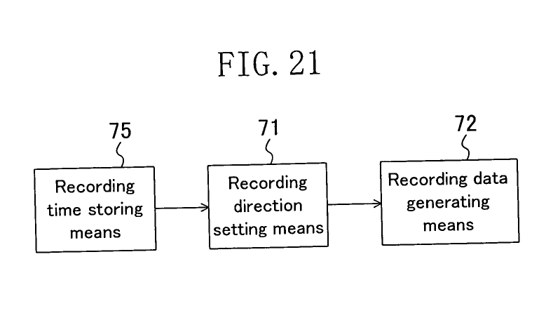

The basic architecture of the recording system of this embodiment is the same as that of Embodiment 1 and hence the description is omitted. As shown in FIG. 21, the imaging device 3 of this embodiment includes recording time storage means 75, recording direction setting means 71 and recording data generating means 72. These means are constructed in the imaging device 3 in the form of software (on a computer program).

The recording time storage means 75 counts the number of recording operations of each line head 31 and stores the counted number. The recording direction setting means 71 changes the recording direction of an image by rotating the image in accordance with a given rule. In this embodiment, the image is rotated by a predetermined angle every time the recording operation is performed a predetermined number of times.

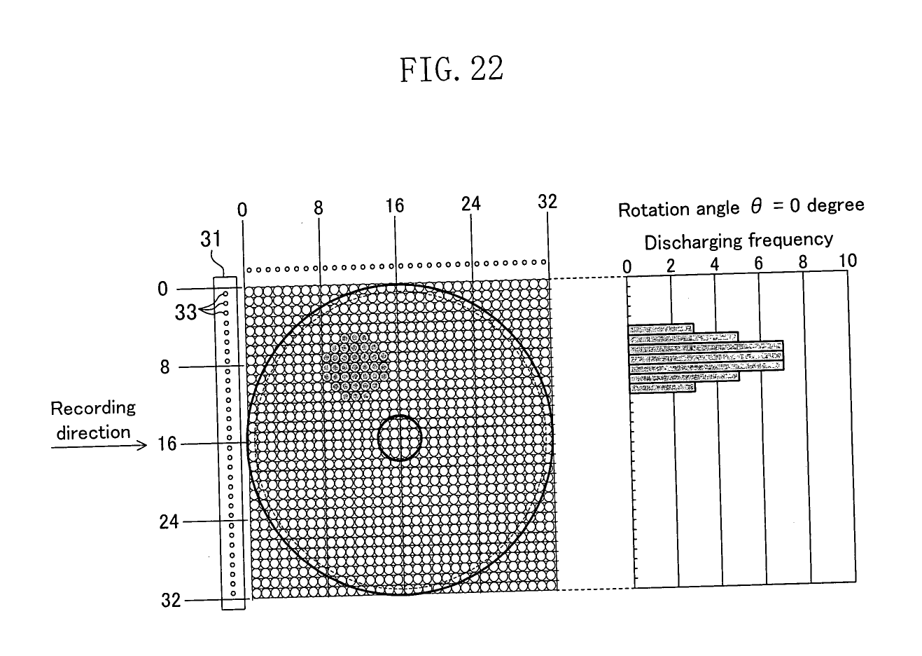

Now, the recording operation of this embodiment will be described by using, as an example of the image, a solid substantial circle as shown in FIG. 22.

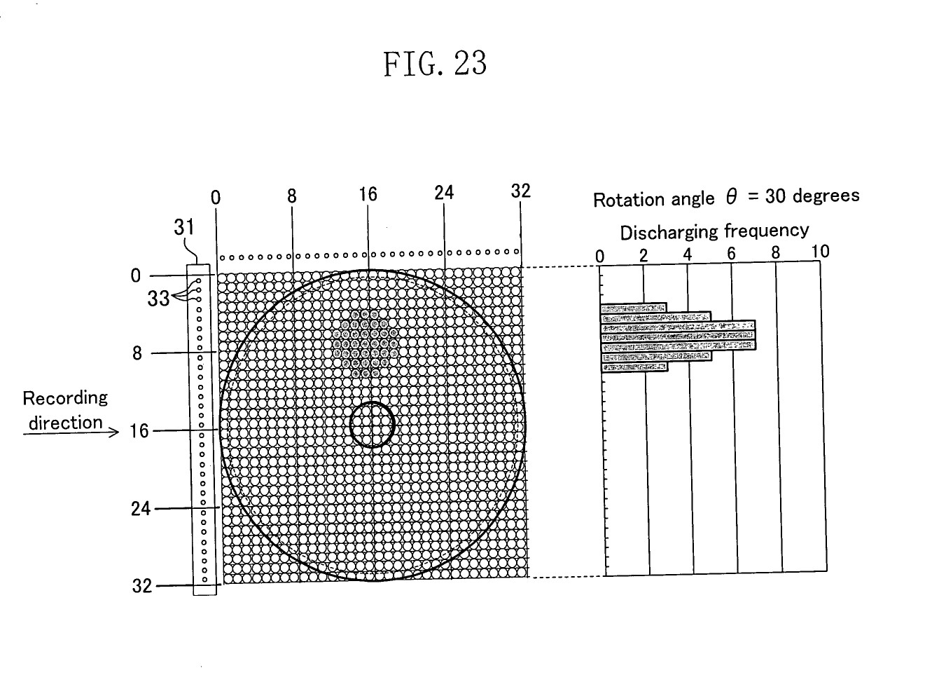

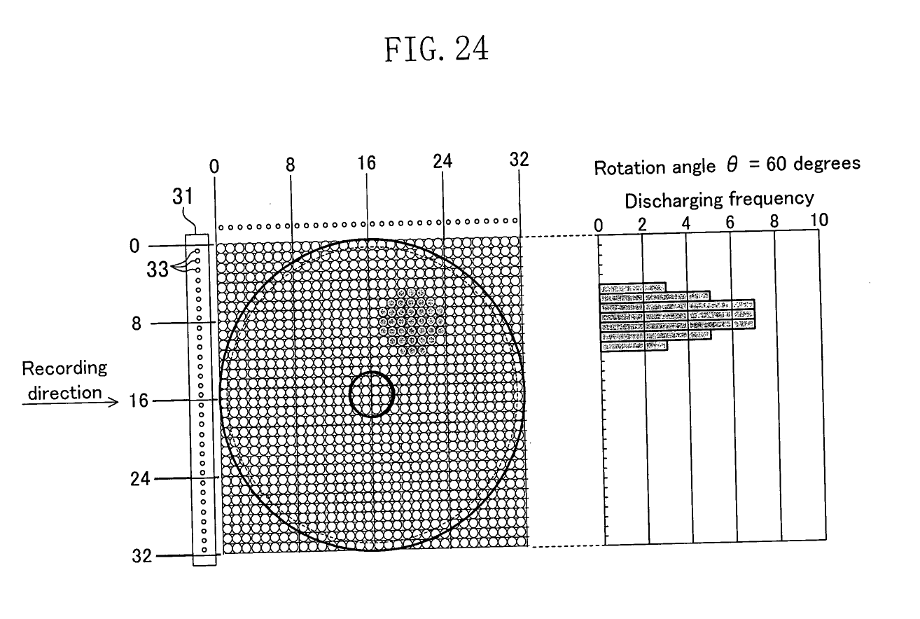

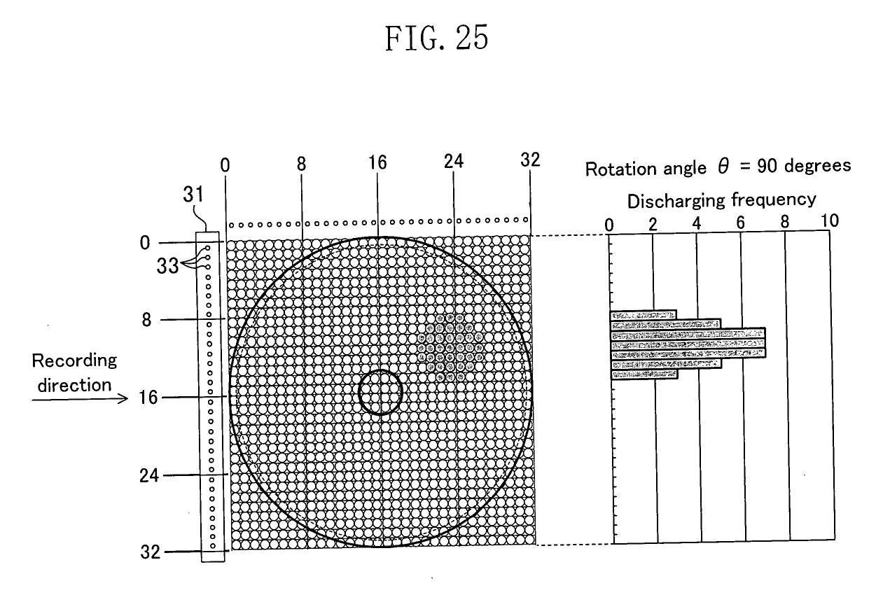

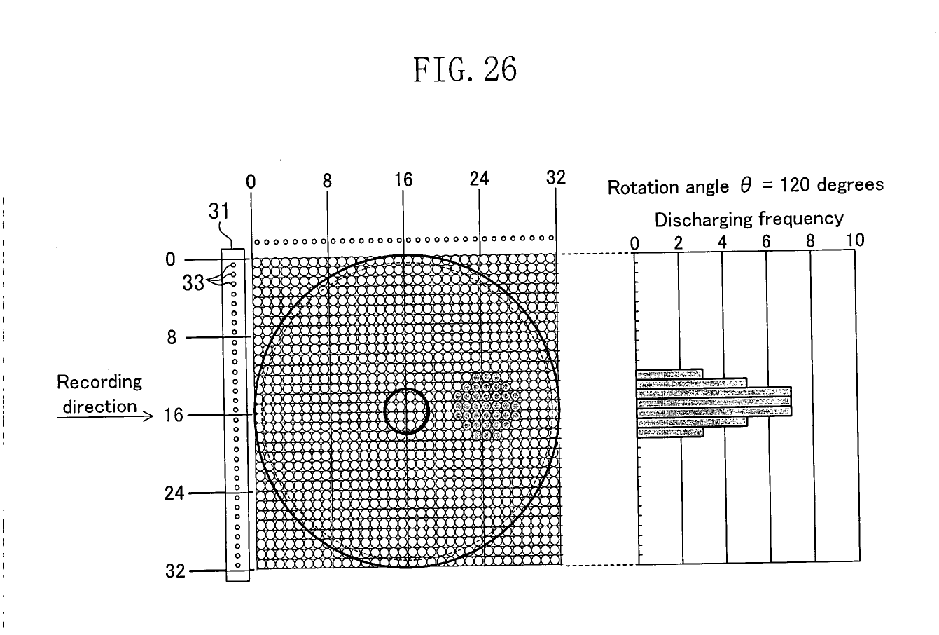

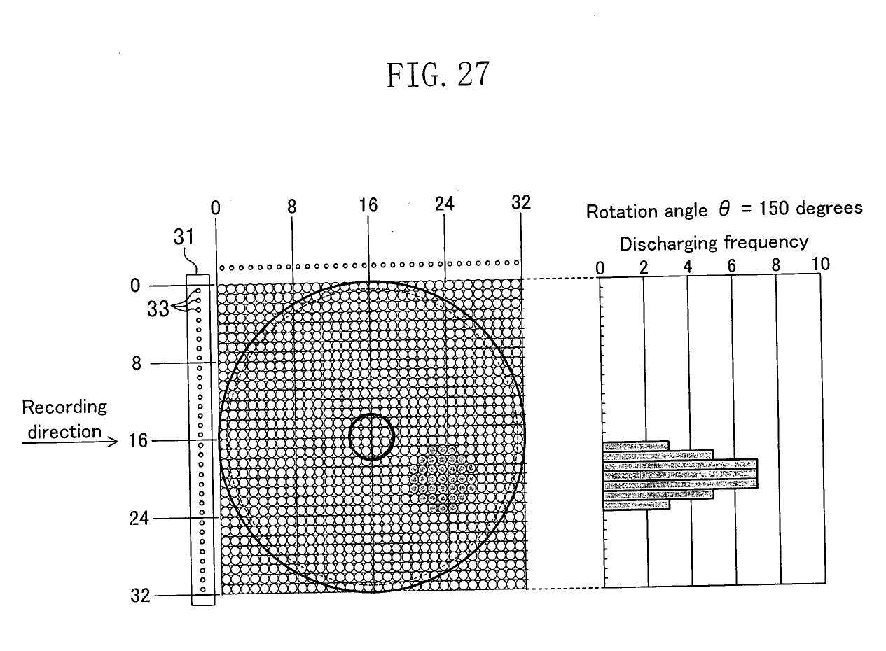

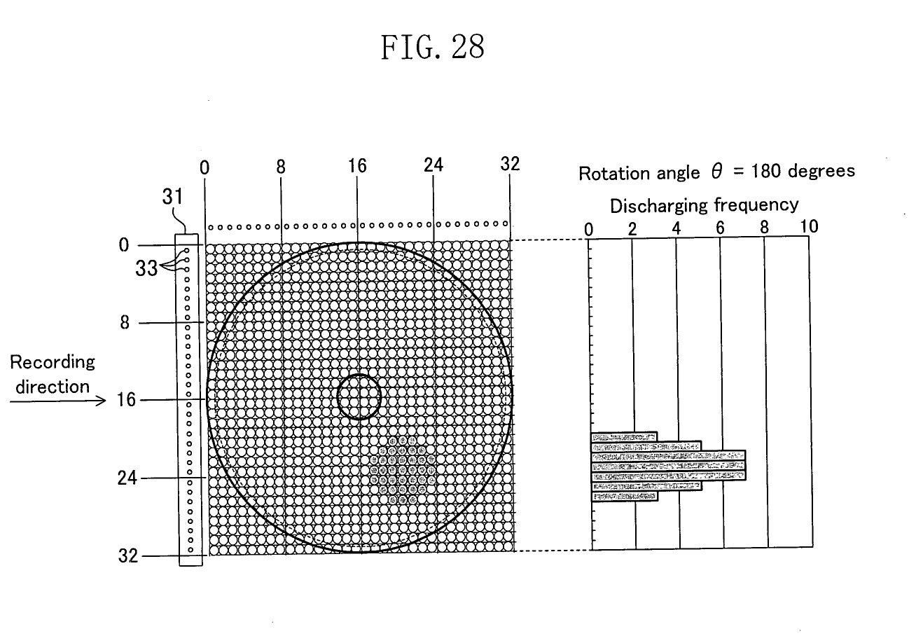

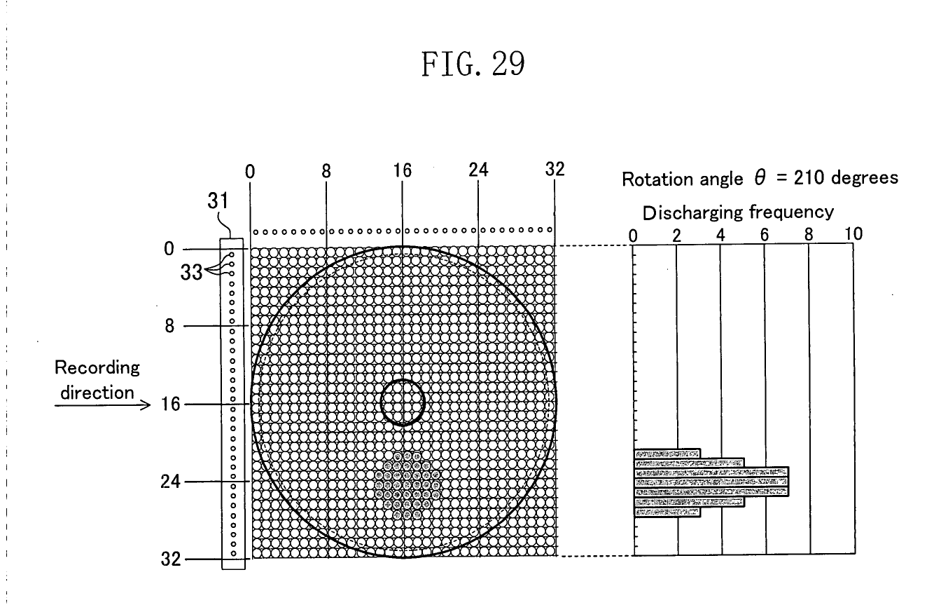

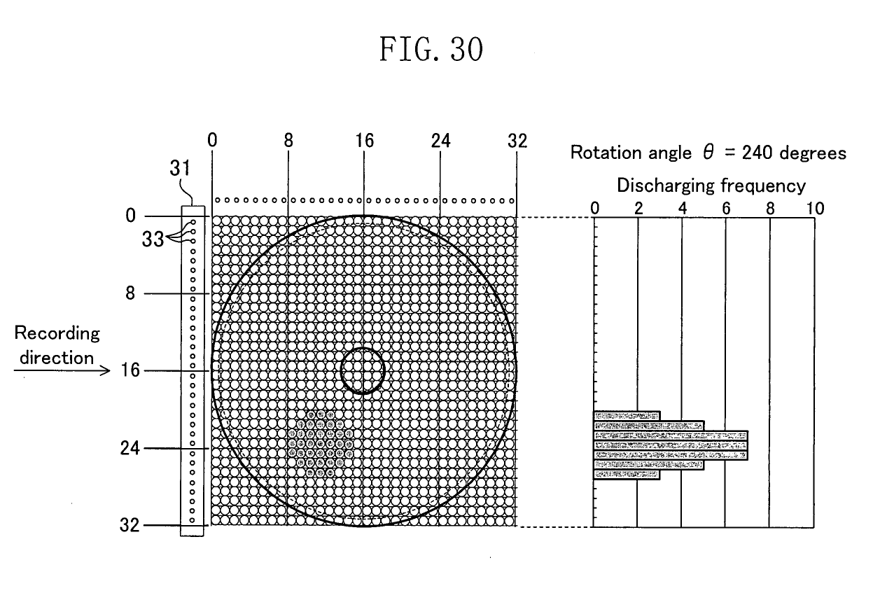

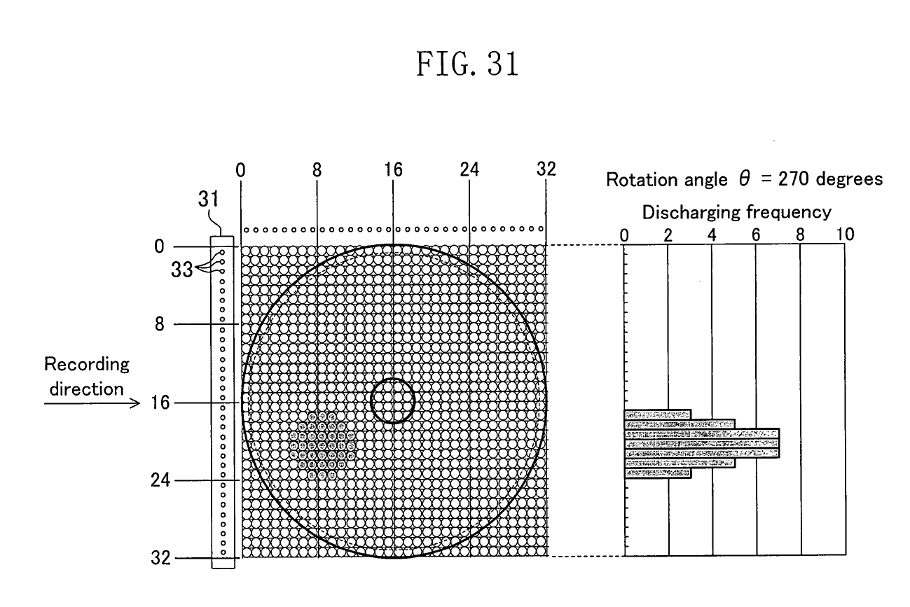

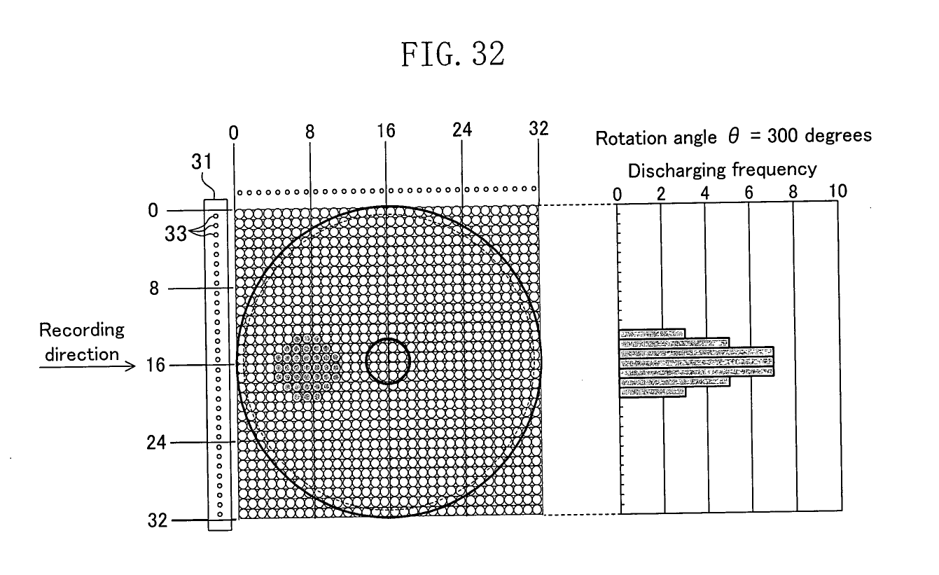

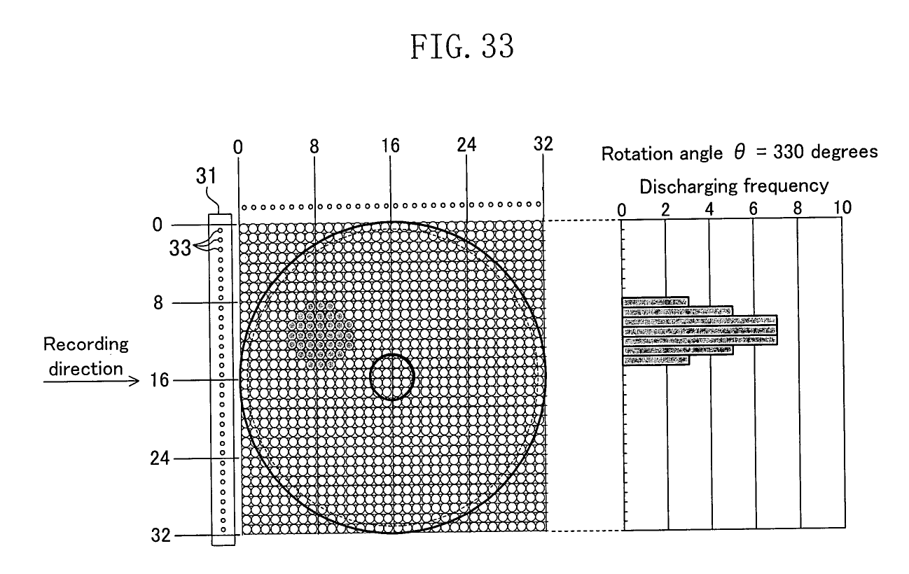

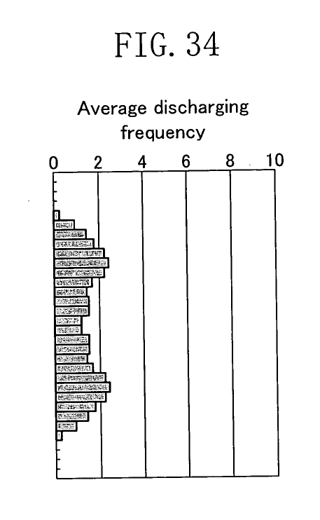

In this example, the image is rotated by 30 degrees every time the image is recorded on 1000 disks 30. The number of disks 30 employed as the reference for converting the image data is not limited to 1000. Each of FIGS. 22 through 33 shows the content of the image and the discharging frequencies of the nozzles corresponding to each rotation angle. FIG. 34 is a graph for showing average values of discharging frequencies of the respective nozzles.

It is understood from comparison between FIG. 22 and FIG. 34 that the maximum value of the discharging frequencies is reduced from 7 to 2.4 by rotating the image during the sequential recording operation. Accordingly, the lifetime of the line head 31 is theoretically increased by 7/2.4 times, i.e., 2.9 times. Also, the dispersion of the discharging frequencies among the nozzles is reduced and the number of used nozzles is increased.

Accordingly, according to this embodiment, the lifetime of the line head 31 can be further elongated as compared with that attained in Embodiment 1. Also, the line head 31 can be more efficiently used.

It is noted that the conversion of the image data is not necessary performed on the basis of the number of recorded disks 30 but may be performed every time a predetermined time elapses. Furthermore, the fabrication line for the disk 30 may be temporarily stopped due to a failure occurring in a part other than the recording device 5 or for another reason, and hence, the sequential recording of the image may be temporarily stopped. Therefore, when the sequential recording is thus stopped, the image data may be converted.

Alternatively, the image data may be converted when the dispersion (such as the standard deviation) of the discharging frequencies among the nozzles exceeds a given value, with storage means (not shown) for storing the discharging frequencies of the respective nozzles 33 of each line head 31 additionally provided.

In this embodiment, the image is rotated by the predetermined angle every time of the conversion of the image data. However, the method for changing the image is not limited to this method by rotating the image by the predetermined angle but the image may be irregularly rotated. For example, a random number generator (not shown) may be provided so as to rotate the image by an angle according to a random number generated by the random number generator.

Alternatively, a preferable or optimum rotation angle may be determined in consideration of the history of the rotation angle change and the future recording schedule, with storage means (not shown) for storing the discharging frequencies of the respective nozzles 33 of each line head 31 additionally provided.

For example, prior to the conversion of the image data, the discharging frequencies necessary for the respective nozzles 33 for recording a converted image a given number of times are calculated, the calculated discharging frequency of each nozzle 33 is added to the discharging frequency thereof prior to the image data conversion, and the rotation angle of the image is determined so as to minimize the discharging frequency of a nozzle with the largest total discharging frequency.

Thus, a preferable or optimum rotation angle employed in the conversion of the image data can be determined, so as to further elongate the lifetime of the line head 31.

Alternatively, prior to the conversion of the image data, the discharging frequencies necessary for the respective nozzles 33 for recording a converted image a given number of times are calculated, the calculated discharging frequency of each nozzle 33 is added to the discharging frequency thereof prior to the conversion of the image data, and the rotation angle of the image is determined so as to minimize the dispersion of the discharging frequencies among the respective nozzles of each line head 31. Alternatively, prior to the conversion of the image data, the discharging frequencies necessary for the respective nozzles 33 for recording a converted image a given number of times are calculated, the calculated discharging frequency of each nozzle 33 is added to the discharging frequency thereof prior to the conversion of the image data, and the rotation angle of the image is determined so as to maximize the number of used nozzles of each line head 31. Thus, an optimum or preferable rotation angle for efficiently using the line head 31 can be obtained.

On the other hand, in the case where the number of disks 30 to be recorded is previously determined, the image data is converted optimally or preferably for recording the image on the determined number of disks 30.

For example, when the imaging device 3 accepts an instruction to record an image a predetermined number of times, it is preferred that the discharging frequencies necessary for the respective nozzles 33 of each line head 31 are calculated and that the image data conversion is performed once or more times so as to minimize the discharging frequency of a nozzle with the maximum discharging frequency after the recording of the image the predetermined number of times.

Alternatively, when the imaging device 3 accepts an instruction to record an image a predetermined number of times, the discharging frequencies necessary for the respective nozzles 33 of each line head 31 are calculated and the image data conversion may be performed once or more times so as to minimize the dispersion of the discharging frequencies among the nozzles after the recording of the image the predetermined number of times.

Alternatively, when the imaging device 3 accepts an instruction to record an image a predetermined number of times, the discharging frequencies necessary for the respective nozzles 33 of each line head 31 are calculated and the image data conversion may be performed once or more times so as to maximize the number of used nozzles of each line head 31 after the recording of the image the predetermined number of times.

Modifications

In a complex image in which a plurality of images are arranged as in Embodiment 2, one or more images included in the complex image may be rotated in the aforementioned manner.

For example, every time the recording operation is performed a predetermined number of times (namely, every time the image data is recorded on a predetermined number of disks 30), one or more images included in the complex image may be rotated by a given angle each.

Merely one of or both of the two images included in the complex image may be rotated. In the case where the both images are rotated, the images may be rotated in a similar manner or may be respectively rotated by different rotation angles. The images may be rotated in connection with each other or rotated independently.

Thus, the line head 31 can be further elongated in its lifetime and can be more efficiently used.

### EMBODIMENT 4

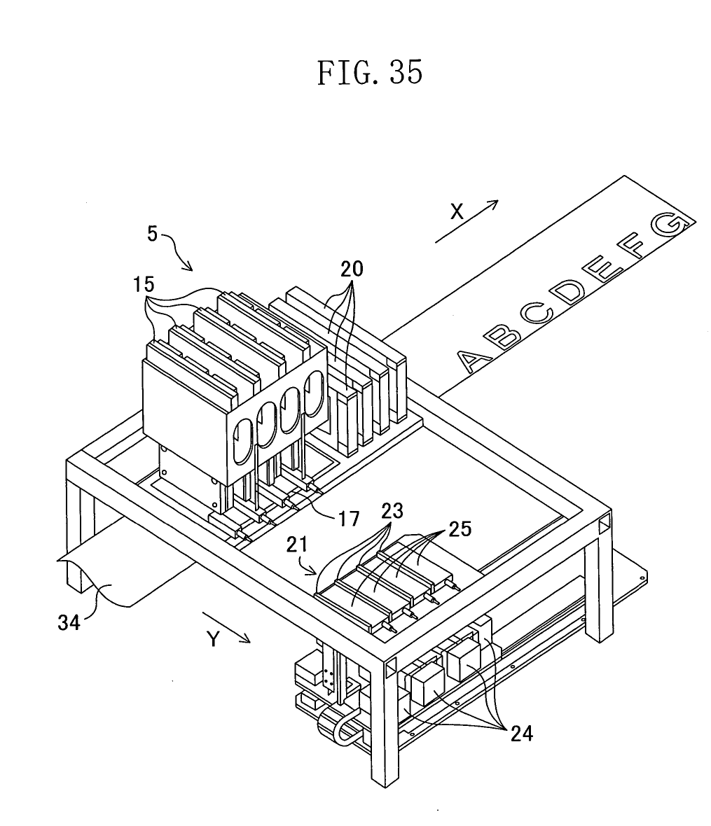

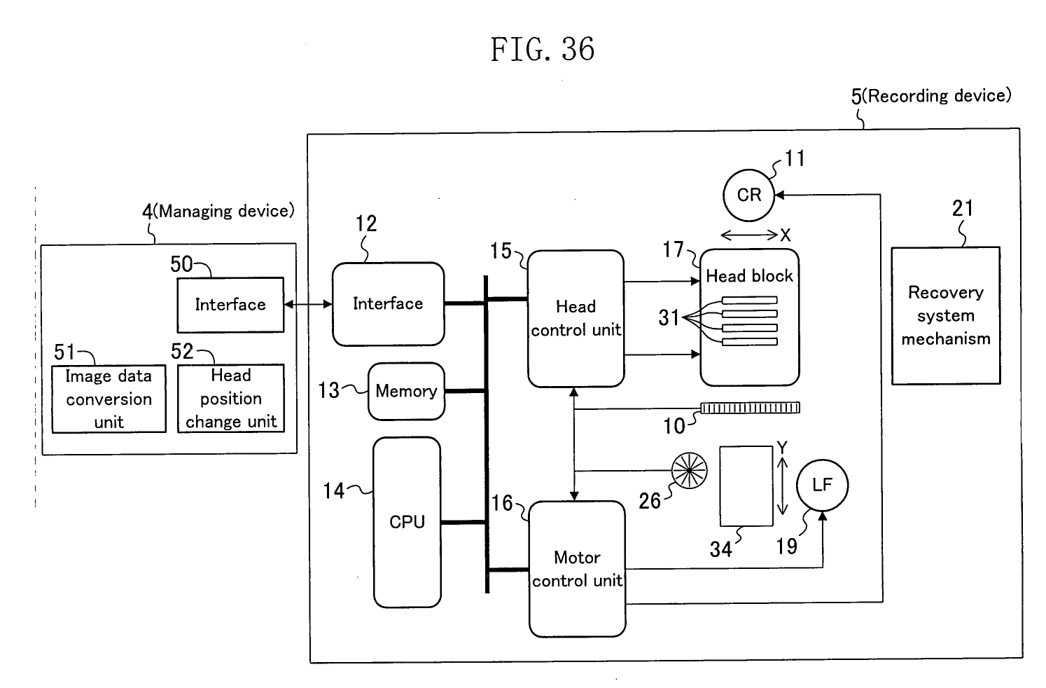

As shown in FIG. 35, an inkjet recording system according to Embodiment 4 includes a recording device 5 having four inkjet line heads 31 (shown in FIG. 36), so as to form a color image by combining inks of four colors of yellow (Y), cyan (C), magenta (M) and black (Bk). The detailed description of a part the same as that of the recording device shown in FIG. 2 is appropriately omitted in this embodiment.

The recording device 5 includes a head control unit 15 for controlling each line head 31, a head block 17 for positioning and fixing all the line heads 31, an ink tank 20 and a recovery system mechanism 21.

The recovery system mechanism 21 recovers the performance of each line head 31 and makes each line head 31 exhibit predetermined performance by performing capping for preventing head nozzle faces from drying and a recovery operation for the heads (such as an operation for forcedly discharging an ink or a purging operation). The recovery system mechanism 21 includes caps 25 for covering the nozzles of the line heads 31, blades 23 and pumps 24.

The head block 17 is transferred along a Y direction by a CR (carriage) motor 11 (not shown in FIG. 35 but shown in FIG. 36), so as to be movable between a position where the line heads 31 perform the recording (namely, a recording position) and a position above the recovery system mechanism 21. Also, the head block 17 is finely moved by the CR motor 11 along the Y direction, so as to finely adjust its position along the Y direction in the vicinity of the recording position.

In this embodiment, a roll sheet 34 is used as a recording medium. The roll sheet 34 extends from a roll not shown along an X direction so as to be continuously fed along the X direction by an LF (line feed) motor 19 (not shown in FIG. 35 but shown in FIG. 36). It is noted that the X direction is perpendicular to the Y direction.

The line head 31 is not particularly specified in its shape and kind as far as it has a plurality of nozzles arranged along the Y direction on at least a part thereof. In this embodiment, as shown in FIGS. 3 and 4, the line head 31 of each color includes 26 unit heads 32 each having a plurality of linearly arranged nozzles 33.

As shown in FIG. 5 (wherein the disk 30 is shown but the disk is replaced with the roll sheet 34 in Embodiment 4 or 5), the line heads 31 of the respective colors are arranged to extend along the Y direction and adjacent to one another along the X direction. In other words, the line heads 31 are arranged along a direction perpendicular to the direction of the relative movement between the line heads 31 and the roll sheet 34. As described above, the line heads 31 are positioned and fixed by the head block 17, and thus, the positional relationship among the line heads 31 is adjusted.

Next, referring to FIG. 36, a control system of this recording system will be described. This recording system includes, in addition to the recording device 5, a managing device 4. The recording device 5 includes an interface unit 12 for sending/receiving image data and various control commands to/from the managing device 4, a memory 13 for storing the image data and a control program, a CPU 14 serving as a control unit for controlling the whole recording device 5, a head control unit 15 for controlling the respective line heads 31, a motor control unit 16 for controlling the CR motor 11 and the LF motor 19, a linear encoder 10 for detecting the position of the head block 17, and a rotary encoder 26 for detecting the fed position of the roll sheet 34 and generating a pulse used as a reference in the control performed by the motor control unit 16 and the head control unit 15.

The managing device 4 includes an interface unit 50, an image data conversion unit 51 and a head position change unit 52. The image data conversion unit 51 and the head position change unit 52 are not particularly specified in their specific structures as far as they can exhibit functions described below. The image data conversion unit 51 and the head position change unit 52 may be constructed in the form of hardware or software.

The basic recording operation of the recording device 5 is substantially the same as that described in Embodiment 1. Difference is that the roll sheet 34 is fed instead of the tray 22. More specifically, the head control unit 15 drives actuators (not shown) of the respective line heads 31Y, 31C, 31M and 31K on the basis of the image data, and the respective line heads 31Y, 31C, 31M and 31K discharge the inks of the respective colors, so as to form a desired image on the roll sheet 34. This recording operation is continuously performed, and hence, the desired image is repeatedly recorded on the roll sheet. Then, when the image is recorded a predetermined number of times, the head control unit 15 terminates the discharging operation of the line heads 31.

After terminating the discharging operation, the motor control unit 16 drives the CR motor 11, so as to move the line heads 31 toward the recovery system mechanism 21. Thereafter, the recovery system mechanism 21 cleans the head nozzles faces, caps the head nozzles for preventing drying and the like (i.e., performs the recovery operation). Thus, the line heads 31 are restored to a state prior to the start of the recording operation.

The recovery operation of the line heads 31 may be appropriately performed during the sequential recording operation. Specifically, after recording the image a given number of times, the recording operation is once halted to perform the recovery operation, and then the recording operation is resumed. In the case where the instructed number of times of recording is very large, such a recovery operation is preferably appropriately performed during the sequential recording operation.

In the recording system of this embodiment, in addition to the aforementioned basic operation, the image data is converted so as to shift the image to be recorded along the Y direction and the position of the head block 17 is shifted along the Y direction in accordance with the conversion, so that the same image can be recorded by using a different combination of nozzles on the basis of the converted image data. Next, the conversion of the image data and the recording operation on the basis of the converted image data will be described.

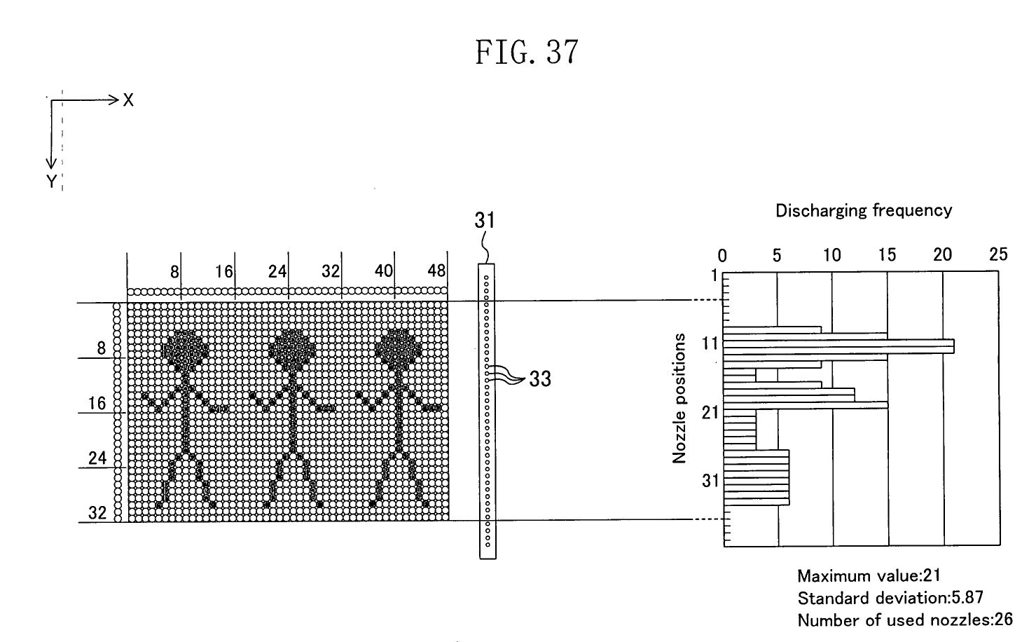

It is herein assumed that an image as shown in FIG. 37 is recorded as an example of the image to be recorded. In this example, it is assumed that the size of an image region (the maximum recordable region) corresponds to the size of 32×48 ink dots, and that each line head 31 has linearly arranged 40 nozzles 33. In FIG. 37, a graph for showing the discharging frequencies of the respective nozzles 33 necessary for recording the image is also shown.

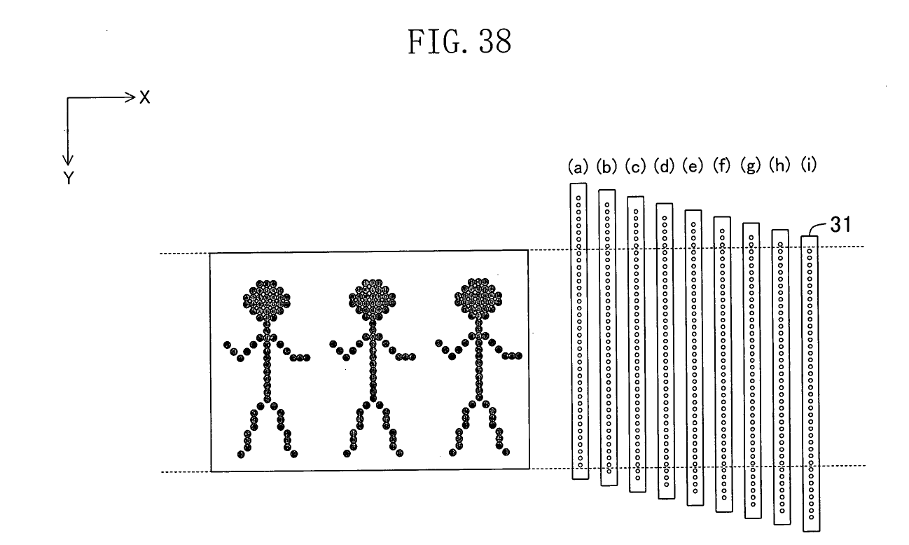

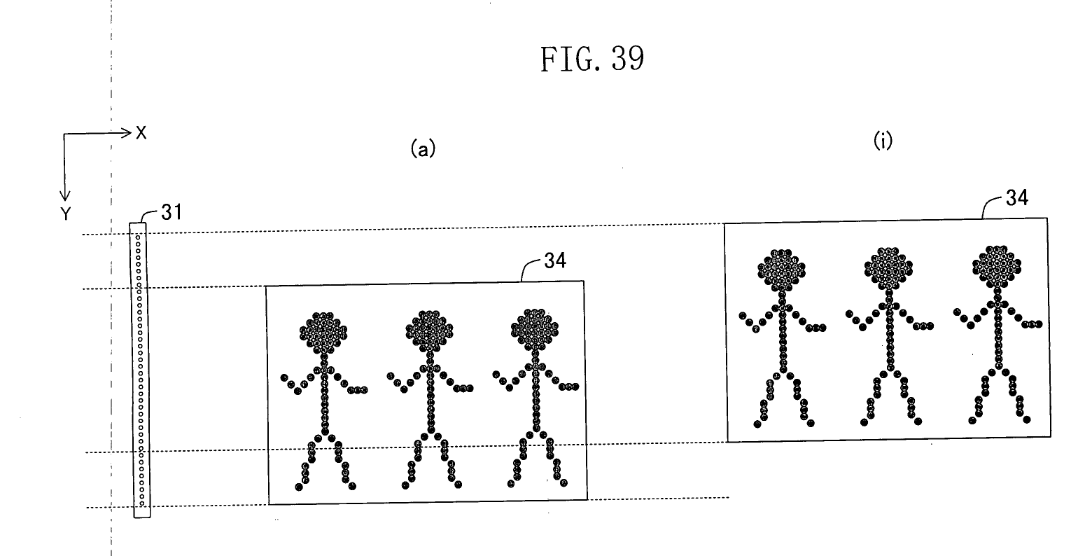

In this example, the number of dots necessary for the image region along the vertical direction is 32 but the number of nozzles of the line head 31 is 40. Therefore, even when the line head 31 is shifted along the Y direction, the same image can be recorded as far as 32 nozzles 33 are disposed above the roll sheet 34. In this example, the relative position between the roll sheet 34 and the line head 31 can be any of nine positions (a) through (i) shown in FIG. 38. In other words, the number of combinations of used nozzles is 9. FIG. 39 is a diagram for showing the relative positions obtained by changing the position of the roll sheet 34 against the recording head 31. The positions (a) and (i) of FIG. 39 respectively correspond to the positions (a) and (i) of FIG. 38. It is understood from FIG. 39 that the same image can be recorded by using a different combination of nozzles.

However, if merely the line head 31 is shifted along the Y direction without changing the combination of used nozzles, the recorded image is shifted along the Y direction correspondingly to the shift of the line head 31. Therefore, in this embodiment, the image data is converted in accordance with the shift of the line head 31, so as to change the combination of used nozzles. Specifically, the image data is converted so that the image to be recorded can be shifted along the opposite direction to the shifting direction of the line head 31 by the same shifting amount.

In this example, the shift of the line head 31 and the conversion of the image data are performed every time the line head 31 is subjected to the recovery operation. In other words, the shift of the line head 31 and the conversion of the image data are performed between a time before the movement of the line head 31 toward the recovery system mechanism 21 and a time after the movement of the line head 31 to the recording position from the vicinity of the recovery system mechanism 21. However, the time when the shift of the line head 31 and the conversion of the image data are performed is not particularly specified, and for example, they may be performed every time a predetermined number of images are recorded. Also, the timing of the shift of the line head 31 and the like may be appropriately specified by a user.

In this example, when the line head 31 moves toward the recovery system mechanism 21, the head position change unit 5 of the managing device 4 changes the set position of the line head 31 successively to the positions (a) through (i) of FIG. 38 in this order. On the other hand, the image data conversion unit 51 converts the image data for shifting the image to be recorded in accordance with the set position changed by the head position change unit 52, so that the recording position on the roll sheet 34 cannot be changed through the change of the set position. For example, when the set position of the line head 31 prior to the recovery operation is the position (a), the head position change unit 52 selects the position (b) as the changed set position. In other words, the head position change unit 52 shifts the set position of the line head 31 downward of FIG. 38 by a distance corresponding to one nozzle. Then, the image data conversion unit 51 converts the image data so that the image to be recorded can be shifted upward of FIG. 38 by a distance corresponding to one nozzle.

Information of the changed set position is sent to the motor control unit 16 of the recording device 5, and the motor control unit 16 controls the CR motor 11 on the basis of the output signal from the linear encoder 10 so as to place the line head 31 in the changed set position. As a result, the line head 31 is set in the changed set position after the recovery operation. Also, the converted image data is sent to the head control unit 15 and the head control unit 15 controls the line head 31 on the basis of the converted image data. As a result, the same images are formed by using different combinations of nozzles before and after the recovery operation.

In this manner, in the recording system of this embodiment, the line head 31 is shifted along the Y direction and the image data is converted so as to shift the image to be recorded along the opposite direction by the same amount. Therefore, the same images can be formed by using different combinations of nozzles. Accordingly, the dispersion of the discharging frequencies among the nozzles is reduced, so that the lifetime of the line head 31 can be elongated and the line head 31 can be efficiently used.

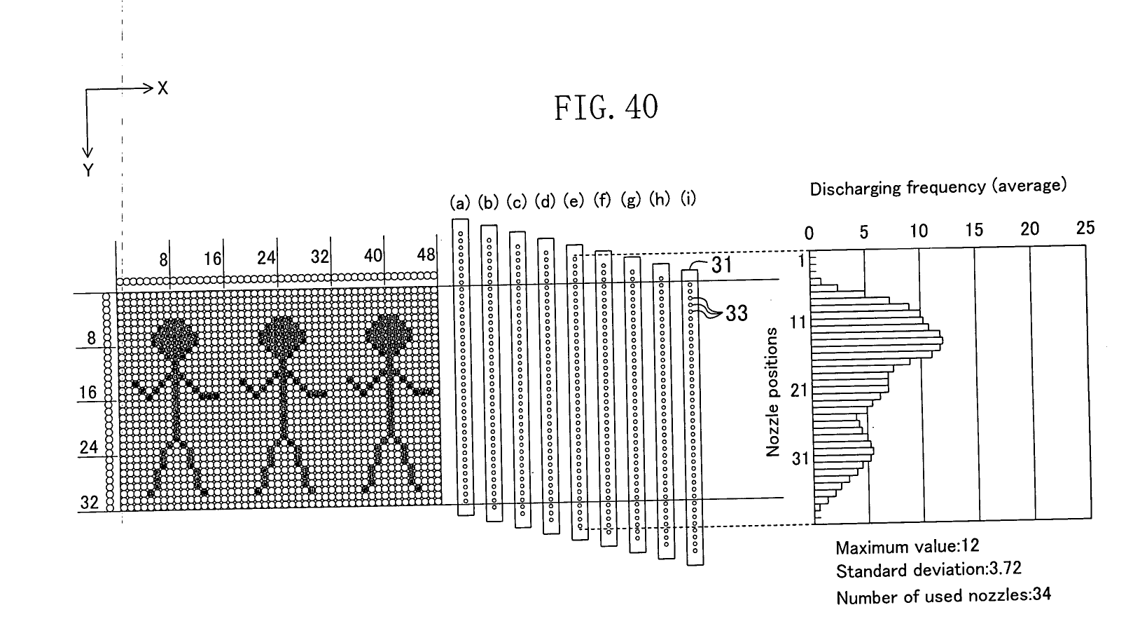

Next, the effects of the recording system of this embodiment will be specifically described on the basis of the exemplified image. FIG. 40 shows a graph of average discharging frequencies of the respective nozzles obtained when the image shown in FIG. 40 is continuously recorded with the set position of the line head 31 shifted successively to the positions (a) through (i). It is understood from comparison between FIG. 40 and FIG. 37 that the dispersion of the discharging frequencies is reduced by changing the set position of the line head 31. In these drawings, the “maximum value” means the discharging frequency of a nozzle with the maximum discharging frequency, and the “number of used nozzles” means the number of nozzles that discharge the ink at least once in recording the image. The “standard deviation” means the dispersion of the discharging frequencies among the nozzles.

The maximum value of the discharging frequency is 21 when the position of the line head 31 is not changed (as shown in FIG. 37), but the maximum value is reduced to 12 by changing the position of the line head 31 (as shown in FIG. 40). In general, the lifetime of a head is regarded to depend upon the maximum value of the discharging frequencies, and therefore, according to this embodiment, the lifetime of the line head is theoretically increased by 21/12 times, i.e., 1.7 times.

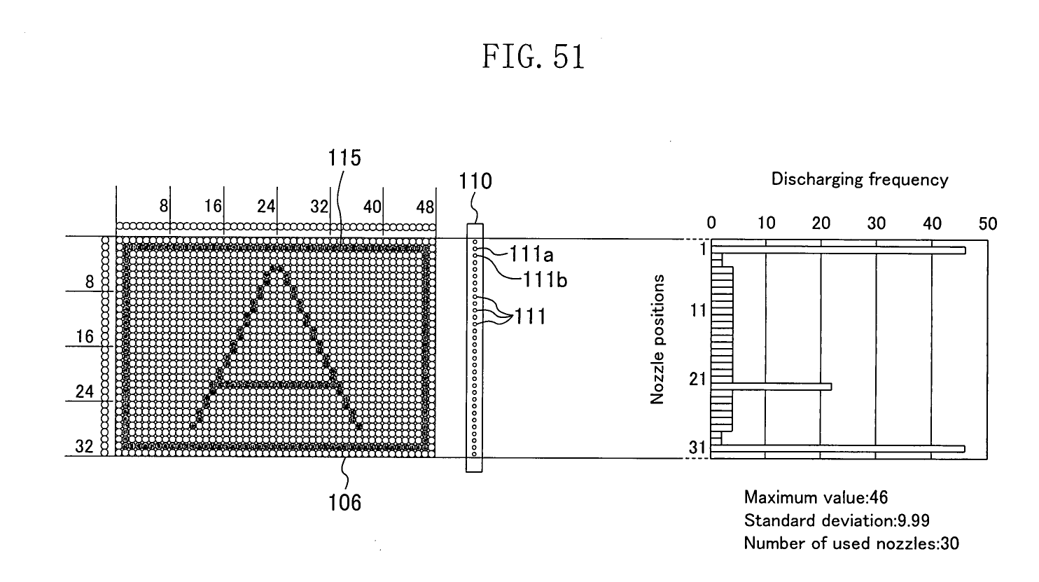

The recording system of this embodiment exhibits a remarkable effect particularly when an image including a line extending along the X direction, such as a voucher, is recorded. FIG. 41 shows average discharging frequencies of the respective nozzles obtained when an image shown in FIG. 41 is recorded with the set position of the line head 31 successively changed to the positions (a) through (i). As is obvious from FIGS. 41 and 51, the dispersion of the discharging frequencies is largely reduced by shifting the line head 31 along the Y direction. Also, as is understood from FIG. 51, if the set position of the line head 31 is not changed, a nozzle 111a used for recording a line extending along the X direction should discharge the ink as frequently as 46 times, and hence, the maximum value of the discharging frequency is as large as 46. On the other hand, a nozzle 111b adjacent to the nozzle 111a discharges the ink merely twice. Therefore, the dispersion of the discharging frequencies among the nozzles is very large. On the contrary, as is obvious from FIG. 41, a nozzle used for recording a line extending along the X direction is appropriately changed by appropriately changing the set position of the line head 31, and therefore, the average maximum value of the discharging frequency is largely reduced to 8.32. As a result, the lifetime of the line head 31 is theoretically increased by 46/8.32 times, i.e., 5.5 times. In this manner, in the case where specific nozzles should concentrically discharge the ink for forming an image to be recorded, such as the case where the image to be recorded includes a ruled line or a border line, or includes a large number of columns as in a voucher, the recording system of this embodiment particularly exhibits the remarkable effect.

Also, in the creation of vouchers, a plurality of images that are common in at least a part of the image contents are continuously recorded, and hence, the discharging frequencies of the nozzles tend to disperse. In the recording system of this embodiment, however, even in the case where a plurality of images that are common in at least a part of the image contents are continuously recorded, the dispersion of the discharging frequencies can be reduced for the aforementioned reason.

As described so far, according to this embodiment, the maximum discharging frequency of the nozzles of the line head 31 can be reduced, and therefore, the lifetime of the line head 31 can be elongated. Furthermore, the dispersion of the discharging frequencies among the nozzles can be suppressed, and the number of used nozzles can be increased. Therefore, the nozzles of each line head 31 can be comparatively uniformly used, so as to prevent merely a part of nozzles from degrading early. As a result, the line head 31 can be efficiently used.

Also, in general, the viscosity of an ink contained in a nozzle is increased as the time interval of ink discharging from the nozzle is large. However, in the line head 31 of this embodiment, the frequencies of the uses of the respective nozzles are more averaged, and hence, the time intervals of the ink discharging from the respective nozzles 33 are averaged. Accordingly, a difference in the viscosity of the inks contained in the respective nozzles 33 at the time of the ink discharging is reduced, so as to stabilize the ink discharging performance as a whole.

In the above-described embodiment, the position of the line head 31 is changed at the time of the recovery operation, and therefore, there is no need to suspend the recording operation of the recording device 5 merely for changing the position of the line head 31. Accordingly, vouchers and the like can be efficiently created without causing a loss in the recording processing.

Since the CR motor 11 for moving the line head 31 toward the recovery system mechanism 21 is directly used as a driving mechanism for changing the position of the line head, there is no need to provide a dedicated driving mechanism for changing the position of the line head 31. Therefore, there is no need to additionally provide a component, resulting in suppressing the increase of the number of components.

### EMBODIMENT 5

In Embodiment 5, in changing the combination of used nozzles of the line head 31, image data is converted so as not only to shift an image along the Y direction but also to rotate the image.

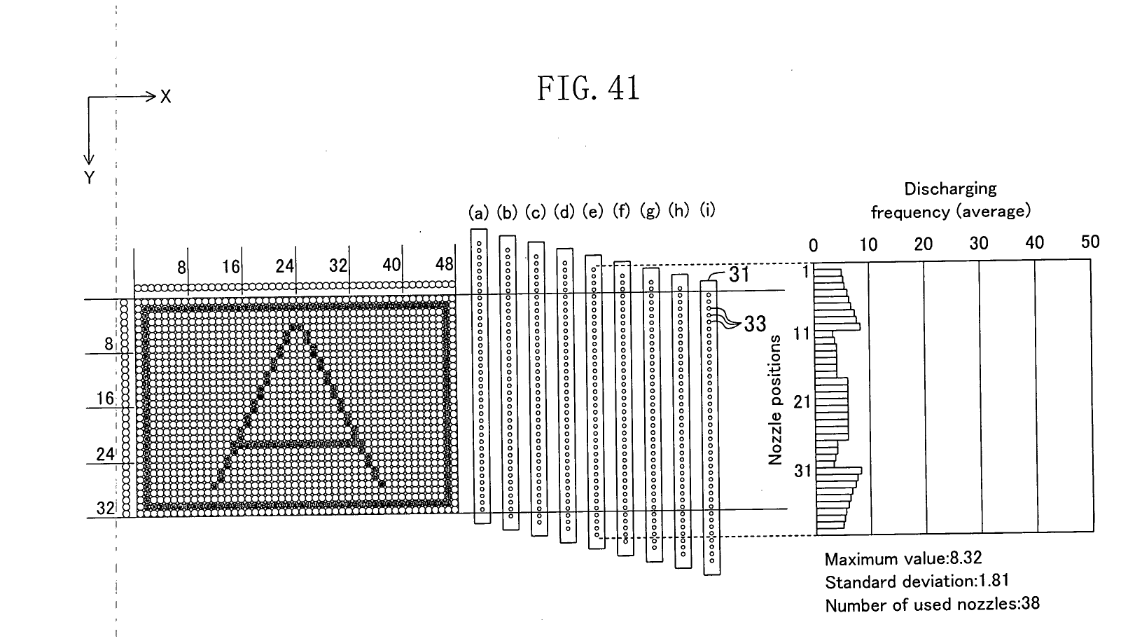

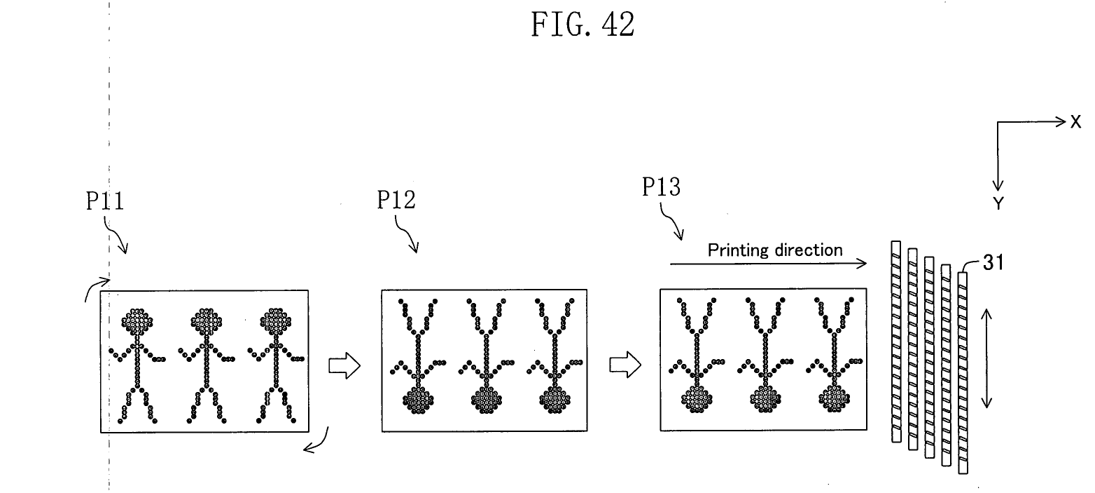

As shown in FIG. 42, an image data conversion unit 51 of this embodiment converts image data so that an image to be recorded can be rotated by 180 degrees (as shown as a position P12 in FIG. 42) as well as shifted along the Y direction (as shown as a position P13 in FIG. 42). The image can be appropriately rotated, and the image may be rotated every time it is shifted along the Y direction (namely, every time the set position of the line head 31 is changed) or rotated regardless of the shift of the image along the Y direction.

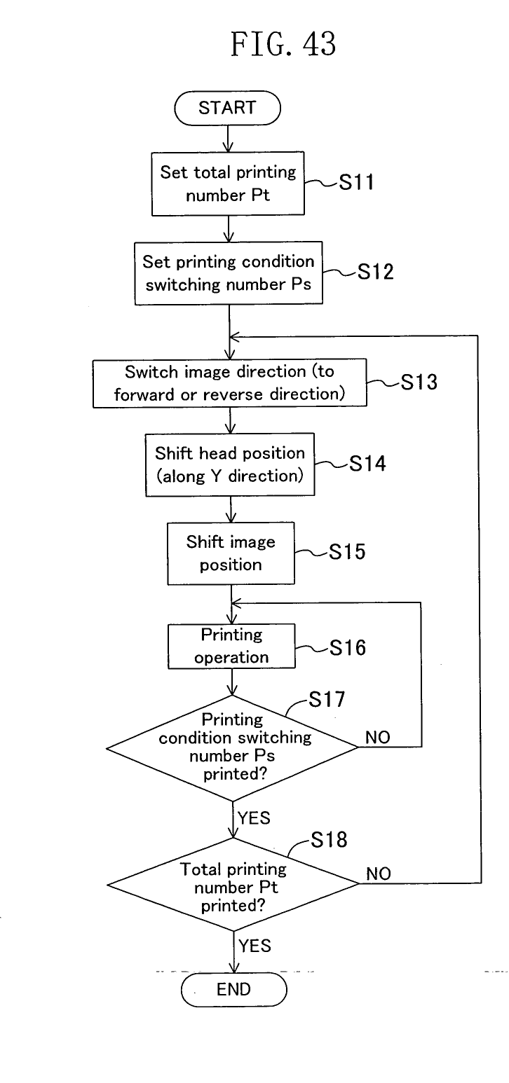

Referring to FIG. 43, the recording operation of this embodiment will be described.

Prior to the recording operation, in step S11, a total printing number Pt is first set. Next, in step S12, a printing condition switching number Ps is set. The step S12 corresponds to a procedure for setting a condition for image data conversion. In this embodiment, the image data is converted every time the recording of the given number Ps of images is finished.

When the setting of steps S11 and S12 is completed, the flow proceeds to step S13 where an image direction is switched. In this embodiment, the image is rotated by 180 degrees. Next, the flow proceeds to step S14 where the position along the Y direction of the line head 31 is shifted. Then, in step S15, the position along the Y direction of the image is changed in accordance with the positional shift of the line head 31. Specifically, the image to be formed after the rotation is shifted in the opposite direction to the shifting direction of the line head 31 by the same amount as the shift of the line head 31.

Next, in step S16, the image data is converted so as to record the rotated and shifted image, and the printing operation (recording operation) is performed on the basis of the converted image data. When the printing operation is completed, it is determined in step S17 whether or not the printing operation of the given number Ps of times has been completed, and when NO, the flow returns to step S16 so as to repeat the printing operation. On the other hand, when it is determined as a result of the determination of step S17 that the printing operation of the given number Ps of times has been completed, the flow proceeds to step S18 where it is determined whether or not the printing operation of the total printing number Pt of times has been completed. When it is determined as a result that the printing operation of the total printing number Pt of times has not been completed, the flow returns to step S13, so as to rotate the image (in step S13), shift the line head 31 along the Y direction (in step S14), shift the image along the Y direction (in step S15), and perform the printing operation by using a different combination of nozzles (in step S16). On the other hand, when it is determined in step S18 that the printing operation of the total printing number Pt of times has been finished, the whole printing is completed.

According to this embodiment, not only the set position of the line head 31 is changed but also the image is rotated, and therefore, the lifetime of the line head 31 can be further elongated and the line head 31 can be more efficiently used.

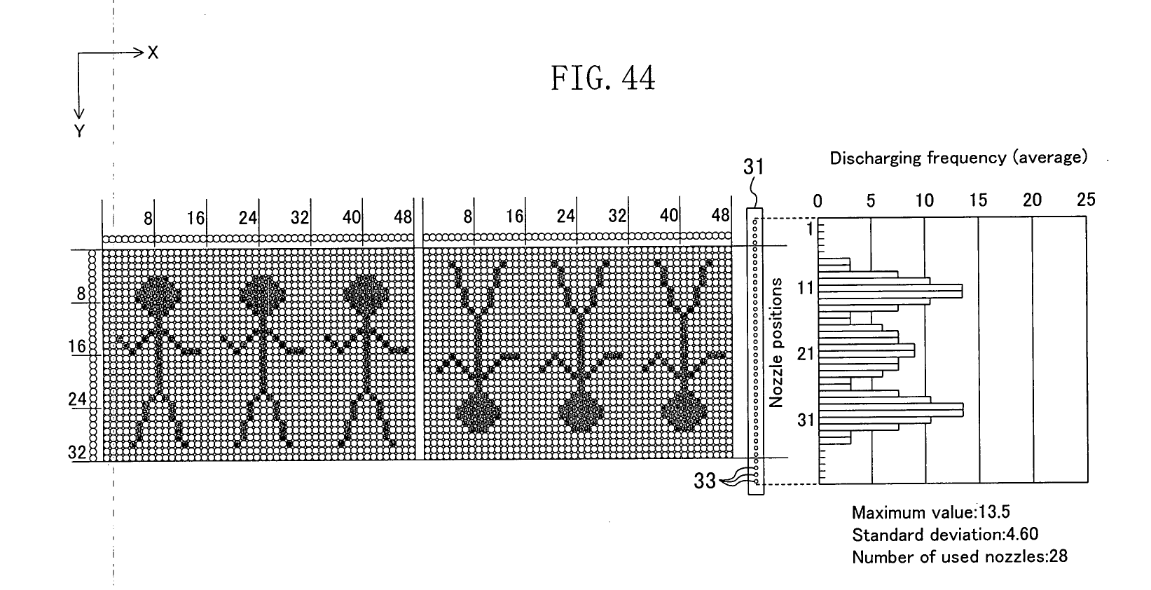

Next, the effect of this embodiment will be specifically described on the basis of an exemplified image. FIG. 44 shows a graph for showing the average discharging frequencies of the respective nozzles obtained when the image is rotated by 180 degrees. It is understood from comparison between FIG. 37 and FIG. 44 that the dispersion of the discharging frequencies among the nozzles can be reduced and the maximum discharging frequency can be reduced also by simply rotating the image by 180 degrees. Thus, the lifetime of the line head 31 can be elongated to some extent merely by converting the image data so as to rotate the image by 180 degrees. In this example, the lifetime of the line head 31 is theoretically increased by 21/13.5 times, i.e., 1.5 times, by rotating the image.

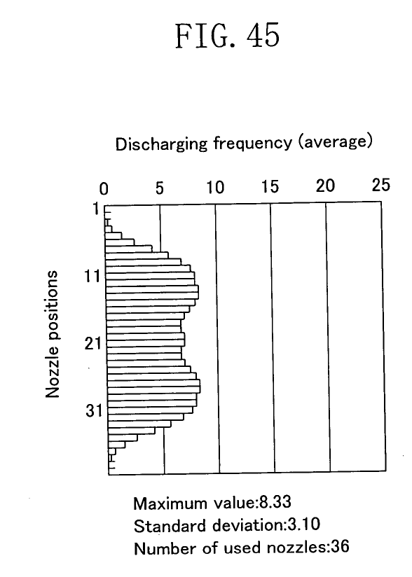

In this embodiment, however, since the image is not only rotated by also shifted along the Y direction, the lifetime of the line head 31 can be further elongated. FIG. 45 is a graph for showing the average discharging frequencies of the respective nozzles obtained when the image is rotated and the position of the line head 31 is shifted respectively to the positions (a) through (i). As is understood from FIG. 45, the maximum value of the average discharging frequencies of the nozzles is 8.33, and thus, the lifetime of the line head 31 can be theoretically increased by 21/8.33 times, i.e., 2.5 times. Also, the dispersion of the discharging frequencies among the nozzles can be further reduced.

Although the image is rotated by 180 degrees in the aforementioned embodiment, the rotation angle of the image is not limited to 180 degrees. The rotation angle may be appropriately set in accordance with the content of the image.

### ALTERNATIVE EMBODIMENTS

The recording device 5 of each of the aforementioned embodiments uses a combination of line heads 31 of the four colors, but merely one line head may be used. The recording head according to the present invention may be one for recording a single color image. Alternatively, the recording head may be one including a plurality of line heads for discharging an ink of the same color for performing gray scale printing.

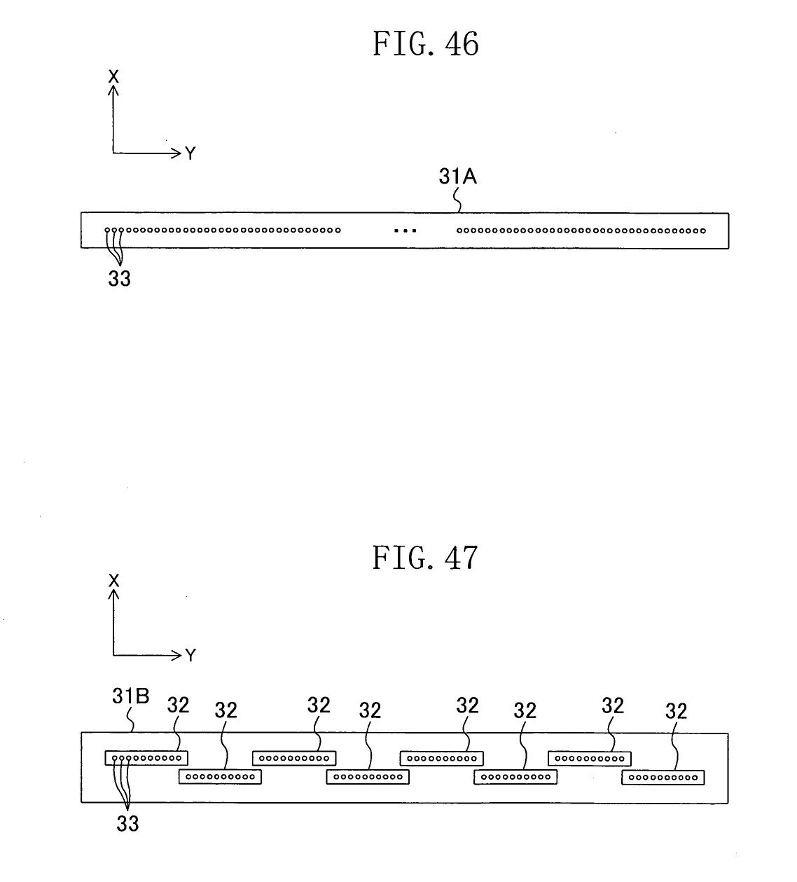

The structure of the recording head is not limited to that of the line head 31 described in each of the aforementioned embodiments as far as it is an inkjet recording head having, on at least a part thereof, a plurality of nozzles arranged along the Y direction. For example, it may be a recording head 31A shown in FIG. 46 having a string of nozzles arranged along the Y direction. Alternatively, it may be a recording head 31B shown in FIG. 47 including unit heads 32 arranged in a zigzag manner along the Y direction.

The longitudinal direction (a first direction) of the line head 31 need not be orthogonal to the transferring direction (a second direction) of the recording medium as far as they cross each other.

In each of Embodiments 1 through 3, the recording medium used as a recording target is he disk 30 in a circular shape. However, the recording medium is not limited to the circular disk 30 but may be a disk in another shape such as a regular polygonal shape. Also, the recording medium may be a medium other than the disk. The recording face of the recording medium may be in any of a circular, a regular polygonal or another shape.

In each of Embodiments 1 through 3, the recording medium is not limited to one prepared for each image such as a DVD-ROM disk or the like but may be one on which a plurality of images are repeatedly recorded. For example, the recording medium may be a roll sheet or the like.

In Embodiment 4 or 5, the conversion of the image data and the positional shift of the line head 31 are performed by the managing device 4 present outside the recording device 5. However, one or both of the conversion of the image data and the positional shift of the line head 31 may be performed by the recording device 5 itself. One or both of the image data conversion unit 51 and the head position change unit 52 may be provided in the recording device 5.

In Embodiment 4 or 5, the relative positions of the recording head and the recording medium are changed by moving the recording head. However, the recording medium may be moved instead with the recording head fixed. Alternatively, both the recording head and the recording medium may be moved.

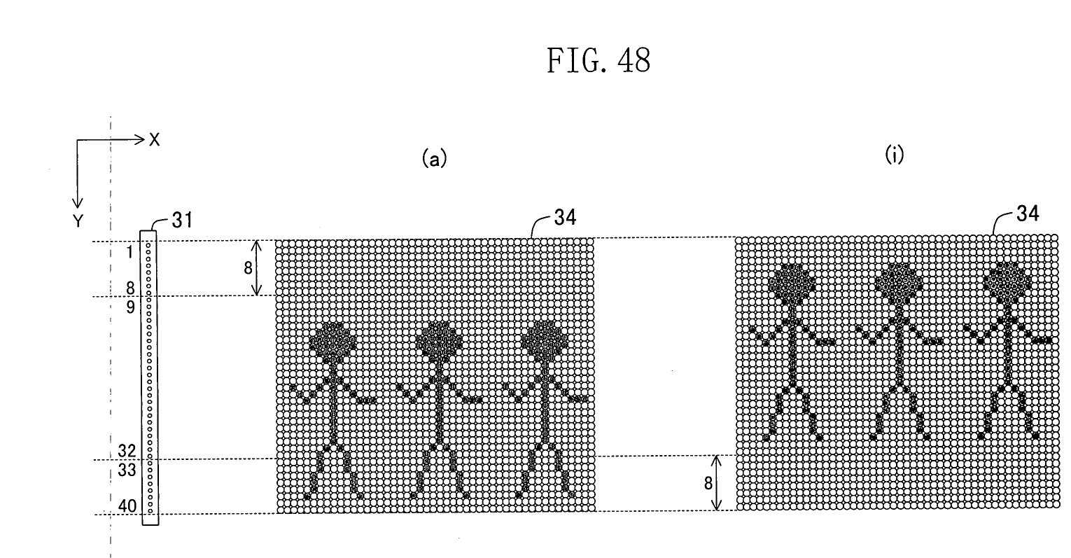

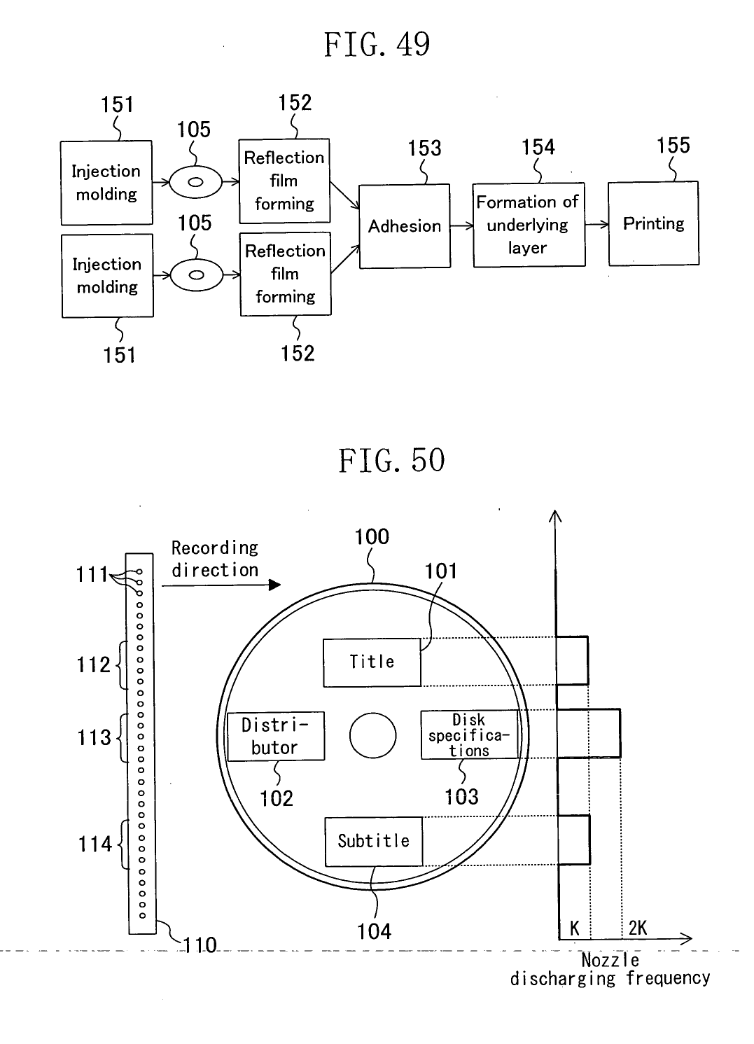

Alternatively, without changing the relative positions of the recording head and the recording medium, the image to be formed may be shifted along the Y direction so as to change the combination of used nozzles. For example, as shown in FIG. 48, without changing the relative positions of the line head 31 and the roll sheet 34, the used nozzles alone may be changed. In this case, however, the recording position on the roll sheet 34 is changed. Therefore, this modification is suitably employed when an accurate recording position is not severely demanded.

In Embodiment 4 or 5, the recording medium is not limited to the roll sheet 34 but may be cut paper. The material of the recording medium is not limited to paper but may be any of other materials such as a building material, a sheet metal, a corrugated fiberboard and plastic. The shape of the recording medium is not limited to a square but may be any of other shapes such as a regular polygonal shape and a circular shape.

As described so far, the present invention exhibits the remarkable effect particularly when the same image is recorded on a large scale. Specifically, the present invention is particularly effective for repeatedly recording the same image, for example, for recording labels on CD-ROMs or DVD-ROMs or creating vouchers.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within meets and bounds of the claims, or equivalence of such meets and bounds are therefore intended to embraced by the claims.

1. An inkjet recording system comprising:
an inkjet recording head having a plurality of nozzles arranged along a first direction;
a moving mechanism for supporting said recording head and/or a recording medium and moving said recording head and said recording medium relatively to each other along a second direction not parallel to said first direction;
an image data converter for converting image data for recording a desired image from a given recording direction in such a manner that said recording direction of said image is changed by rotating said image; and
a controller for accepting said converted image data obtained said image data converter and controlling said recording head and said moving mechanism for recording said image on said recording medium with said second direction set as a changed recording direction.

2. The inkjet recording system of claim 1,
wherein said image data converter calculates necessary discharging frequencies of said nozzles of said recording head with respect to each of a plurality of recording directions and selects, as said changed recording direction, one of said plurality of recording directions on the basis of a predetermined evaluation criterion.

3. The inkjet recording system of claim 1,
wherein said image data converter calculates necessary discharging frequencies of said nozzles of said recording head with respect to each of a plurality of recording directions and selects, as said changed recording direction, a recording direction for minimizing a discharging frequency of a nozzles with the largest discharging frequency among said plurality of nozzles of said recording head.

4. The inkjet recording system of claim 1,
wherein said image data converter calculates necessary discharging frequencies of said nozzles of said recording head with respect to each of a plurality of recording directions and selects, as said changed recording direction, a recording direction for minimizing a standard deviation of the discharging frequencies among said plurality of nozzles of said recording head.

5. The inkjet recording system of claim 1,
wherein said image data converter calculates necessary discharging frequencies of said nozzles of said recording head with respect to each of a plurality of recording directions and selects, as said changed recording direction, a recording direction for maximizing a number of used nozzles of said recording head.

6. The inkjet recording system of claim 2,
wherein, in changing said recording direction, said image data converter calculates the necessary discharging frequencies with respect to each of said plurality of recording directions obtained by rotating said image by every given angle.

7. The inkjet recording system of claim 1,
wherein said image data is data for recording, from a given linear direction, a complex image in which N (wherein N is a natural number of 2 or more) images identical to one another are repeatedly arranged along said linear direction,
said image data converter changes said complex image by rotating at least one image out of said images included in said complex image for making a recording direction of said at least one image different from a recording direction of at least one of the other images, and converts said image data into image data for recording said changed complex image from said linear direction, and
said controller accepts said converted image data and controls said recording head and said moving mechanism for recording said images included in said changed complex image on said recording medium with said second direction set as said linear direction.

8. The inkjet recording system of claim 7,
wherein said recording medium is N in number and said N recording media are arranged along said second direction, and
said controller accepts said converted image data and controls said recording head and said moving mechanism for recording said images included in said changed complex image on each of said recording media with said second direction set as said linear direction.

9. The inkjet recording system of claim 7,
wherein said image data converter calculates necessary discharging frequencies of said nozzles of said recording head with respect to a plurality of complex images, and selects one of said complex images as said changed complex image on the basis of a predetermined evaluation criterion.

10. The inkjet recording system of claim 7,
wherein said image data converter calculates necessary discharging frequencies of said nozzles of said recording head with respect to each of a plurality of complex images and selects, as said changed complex image, a complex image for minimizing a discharging frequency of a nozzles with the largest discharging frequency among said plurality of nozzles of said recording head.

11. The inkjet recording system of claim 7,
wherein said image data converter calculates necessary discharging frequencies of said nozzles of said recording head with respect to each of a plurality of complex images and selects, as said changed complex image, a complex image for minimizing a standard deviation of the discharging frequencies among said plurality of nozzles of said recording head.

12. The inkjet recording system of claim 7,
wherein said image data converter calculates necessary discharging frequencies of said nozzles of said recording head with respect to each of a plurality of complex images and selects, as said changed complex image, a complex image for maximizing a number of used nozzles of said recording head.

13. The inkjet recording system of claim 7,
wherein said image data converter changes said complex image by rotating said N images included in said complex image by every 360°/N.

14. The inkjet recording system of claim 7,
wherein one of said images included in said changed complex image is set for minimizing a discharging frequency of a nozzle with the largest discharging frequency among said plurality of nozzles of said recording head.

15. The inkjet recording system of claim 7,
wherein one of said images included in said changed complex image is set for minimizing a standard deviation of the discharging frequencies among said plurality of nozzles of said recording head.

16. The inkjet recording system of claim 7,
wherein one of said images included in said changed complex image is set for maximizing a number of used nozzles of said recording head.

17. An inkjet recording system comprising:
an inkjet recording head having a plurality of nozzles arranged along a first direction;
a moving mechanism for supporting said recording head and/or a recording medium and moving said recording head and said recording medium relatively to each other along a second direction not parallel to said first direction;
an image data supplier for supplying image data for recording a desired image from a given recording direction; and
a controller for accepting said image data and controlling said recording head and said moving mechanism for recording said image on said recording medium with said second direction set as said recording direction,
wherein said image data supplier converts said image data, after said image is recorded on one or more recording media, in such a manner that said recording direction of said image is changed by rotating said image, and supplies said converted image data.

18. The inkjet recording system of claim 17,
wherein said controller repeatedly performs recording of said image, and
said image data supplier converts said image data every time the recording is performed a given number of times.

19. The inkjet recording system of claim 17,
wherein said controller repeatedly and continuously performs recording of said image, and
said image data supplier converts said image data when the continuously performed recording by said controller is halted.

20. The inkjet recording system of claim 17, further comprising a storage for storing discharging frequencies of said nozzles of said recording head,
wherein said image data supplier converts said image data when a standard deviation of the discharging frequencies among said nozzles of said recording head exceeds a given value.

21. The inkjet recording system of claim 17,
wherein said image data supplier converts said image data in such a manner that said image is rotated by every given angle.

22. The inkjet recording system of claim 17, further comprising a random number generator for generating a random number,
wherein said image data supplier converts said image data in such a manner that said image is irregularly rotated in accordance with a random number generated by said random number generator.

23. The inkjet recording system of claim 17, further comprising a storage for storing discharging frequencies of said nozzles of said recording head,
wherein said image data supplier calculates, prior to conversion of said image data, a discharging frequency of each nozzle of said recording head necessary for recording a converted image a given number of times, adds said calculated discharging frequency to a discharging frequency of said nozzle obtained before the conversion of said image data, and determines a rotation angle of said image for minimizing a discharging frequency of a nozzle with the largest total discharging frequency in said recording head.

24. The inkjet recording system of claim 17, further comprising a storage for storing discharging frequencies of said nozzles of said recording head,
wherein said image data supplier calculates, prior to conversion of said image data, a discharging frequency of each nozzle of said recording head necessary for recording a converted image a given number of times, adds said calculated discharging frequency to a discharging frequency of said nozzle obtained before the conversion of said image data, and determines a rotation angle of said image for minimizing a standard deviation of discharging frequencies among said nozzles of said recording head.

25. The inkjet recording system of claim 17, further comprising a storage for storing discharging frequencies of said nozzles of said recording head,
wherein said image data supplier calculates, prior to conversion of said image data, a discharging frequency of each nozzle of said recording head necessary for recording a converted image a given number of times, adds said calculated discharging frequency to a discharging frequency of said nozzle obtained before the conversion of said image data, and determines a rotation angle of said image for maximizing the number of used nozzles of said recording head.

26. The inkjet recording system of claim 17,
wherein said image data supplier accepts an instruction for recording a given number of images, calculates necessary discharging frequencies of said nozzles of said recording head, and converts said image data once or more times for minimizing a discharging frequency of a nozzle with the largest discharging frequency in said recording head after recording said given number of images.

27. The inkjet recording system of claim 17,
wherein said image data supplier accepts an instruction for recording a given number of images, calculates necessary discharging frequencies of said nozzles of said recording head, and converts said image data once or more times for minimizing a standard deviation of the discharging frequencies among said nozzles of said recording head after recording said given number of images.

28. The inkjet recording system of claim 17,
wherein said image data supplier accepts an instruction for recording a given number of images, calculates necessary discharging frequencies of said nozzles of said recording head, and converts said image data once or more times for maximizing a number of used nozzles of said recording head after recording said given number of images.

29. The inkjet recording system of claim 17,
wherein said image data is data for recording, from a given linear direction, a complex image in which N (wherein N is a natural number of 2 or more) images identical to one another are repeatedly arranged along said linear direction,
said image data supplier converts said image data for changing said complex image by rotating at least one image out of said images included in said complex image, and
said controller accepts said converted image data and controls said recording head and said moving mechanism for recording said images included in said changed complex image on said recording medium from said second direction set as said linear direction.

30. The inkjet recording system of claim 29,
wherein said recording medium is N in number and said N recording media are arranged along said second direction, and
said controller accepts said converted image data and controls said recording head and said moving mechanism for recording said images included in said changed complex image on each of said recording media from said second direction set as said linear direction.

31. The inkjet recording system of claim 29,
wherein said controller repeatedly performs recording of said complex image, and
said image data supplier converts said image data every time a given number of recording is performed.

32. The inkjet recording system of claim 29,
wherein said controller repeatedly and continuously performs recording of said complex image, and
said image data supplier converts said image data when the continuously performed recording by said controller is halted.

33. The inkjet recording system of claim 29, further comprising a storage for storing discharging frequencies of said nozzles of said recording head,
wherein said image data supplier converts said image data when a standard deviation of the discharging frequencies among said nozzles of said recording head exceeds a given value.

34. The inkjet recording system of claim 29,
wherein said image data supplier converts said image data in such a manner that at least one of said images included in said complex image is rotated by every given angle.

35. The inkjet recording system of claim 29, further comprising a random number generator for generating a random number,
wherein said image data supplier converts said image data in such a manner that at least one of said images included in said complex image is irregularly rotated in accordance with a random number generated by said random number generator.

36. The inkjet recording system of claim 29, further comprising a storage for storing discharging frequencies of said nozzles of said recording head,
wherein said image data supplier calculates, prior to conversion of said image data, a discharging frequency of each nozzle of said recording head necessary for recording a converted image a given number of times, adds said calculated discharging frequency to a discharging frequency of said nozzle obtained before the conversion of said image data, and determines a rotation angle of said image for minimizing a discharging frequency of a nozzle with the largest total discharging frequency in said recording head.

37. The inkjet recording system of claim 29, further comprising a storage for storing discharging frequencies of said nozzles of said recording head,
wherein said image data supplier calculates, prior to conversion of said image data, a discharging frequency of each nozzle of said recording head necessary for recording a converted image a given number of times, adds said calculated discharging frequency to a discharging frequency of said nozzle obtained before the conversion of said image data, and determines a rotation angle of said image for minimizing a standard deviation of the discharging frequencies among said nozzles of said recording head.

38. The inkjet recording system of claim 29, further comprising a storage for storing discharging frequencies of said nozzles of said recording head,
wherein said image data supplier calculates, prior to conversion of said image data, a discharging frequency of each nozzle of said recording head necessary for recording a converted image a given number of times, adds said calculated discharging frequency to a discharging frequency of said nozzle obtained before the conversion of said image data, and determines a rotation angle of said image for maximizing the number of used nozzles of said recording head.

39. The inkjet recording system of claim 29,
wherein said image data supplier accepts an instruction for recording a given number of complex images, calculates necessary discharging frequencies of said nozzles of said recording head, and converts said image data once or more times for minimizing a discharging frequency of a nozzle with the largest discharging frequency in said recording head after recording said given number of complex images.

40. The inkjet recording system of claim 29,
wherein said image data supplier accepts an instruction for recording a given number of complex images, calculates necessary discharging frequencies of said nozzles of said recording head, and converts said image data once or more times for minimizing a standard deviation of the discharging frequencies among said nozzles of said recording head after recording said given number of complex images.

41. The inkjet recording system of claim 29,
wherein said image data supplier accepts an instruction for recording a given number of complex images, calculates necessary discharging frequencies of said nozzles of said recording head, and converts said image data once or more times for maximizing a number of used nozzles of said recording head after recording said given number of complex images.

42. The inkjet recording system of claim 1,
wherein said recording medium has a recording face in a circular shape.

43. The inkjet recording system of claim 1,
wherein said recording medium has a recording face in a regular polygonal shape.

44. The inkjet recording system of claim 42,
wherein said recording medium is a plate-shaped recording medium.

45. The inkjet recording system of claim 1,
wherein said recording head is a fixed type line head, and
said moving mechanism includes a tray for supporting said recording medium and a driving mechanism for driving said tray.

46. The inkjet recording system of claim 1,
wherein said recording head includes a plurality of line heads each having a plurality of nozzles arranged along a given direction, and
said plurality of line heads are arranged along a direction of relative movement between said recording head and said recording medium.

47. The inkjet recording system of claim 46,
wherein each of said plurality of line heads is fixed, and
said moving mechanism includes a tray for supporting said recording medium and a driving mechanism for moving said tray along the direction of the relative movement.

48. An inkjet recording system comprising:
an inkjet recording head having a plurality of nozzles arranged along a first direction;
a moving mechanism for supporting said recording head and/or a recording medium and moving said recording head and said recording medium relatively to each other along a second direction not parallel to said first direction in a recording operation;
a controller for accepting image data for recording an image by allowing said nozzles of said recording head to discharge an ink and for controlling said recording head and said moving mechanism for recording said image on said recording medium; and
an image data converter for converting said image data in such a manner that nozzles used for recording said image are shifted along said first direction in said recording head,
wherein said controller accepts said converted image data and controls said recording head for recording said image with nozzles used for the recording shifted along said first direction.

49. The inkjet recording system of claim 48, further comprising a position changing means for changing a relative position along said first direction of said recording head against said recording medium by a given distance in a non-recording operation,
wherein said image data converter converts said image data in such a manner that said image is shifted along a direction opposite to a direction of the relative movement between said recording head and said recording medium by a distance equal to said given distance.

50. The inkjet recording system of claim 49,
wherein said position changing means includes a carriage motor for driving said recording head along said first direction.

51. The inkjet recording system of claim 48, further comprising:
a recovery system mechanism provided in a position away at least along said first direction from a recording position of said recording head and including at least caps for covering said nozzles of said recording head; and
a driving mechanism for moving said recording head between said recording position and the position of said recovery system mechanism,
wherein said driving mechanism also works as said position changing means.

52. The inkjet recording system of claim 51,
wherein said position changing means changes the relative position along said first direction of said recording head against said recording medium between before moving said recording head toward said recovery system mechanism and after moving said recording head toward said recovery system mechanism and returning said recording head to said recording position.

53. The inkjet recording system of claim 48,
wherein said recording medium is a roll type recording medium,
said moving mechanism includes a feeding mechanism for feeding said roll type recording medium along said second direction, and
said image data converter converts said image data when said roll type recording medium is exchanged.

54. The inkjet recording system of claim 49,
wherein said recording medium is a roll type recording medium,
said moving mechanism includes a feeding mechanism for feeding said roll type recording medium along said second direction, and
said position changing means changes the relative position along said first direction of said recording head against said recording medium when said roll type recording medium is exchanged.

55. The inkjet recording system of claim 48,
wherein said image includes a line extending along said second direction.

56. The inkjet recording system of claim 48,
wherein a plurality of images at least partly common in image contents are continuously recorded.

57. The inkjet recording system of claim 48,
wherein said image data converter converts said image data in such a manner that said image is shifted along said first direction and is rotated.

58. The inkjet recording system of claim 57,
wherein said image data converter rotates said image by 180 degrees.

59. An inkjet recording system comprising:
an inkjet recording head having a plurality of nozzles arranged along a first direction;
a moving mechanism for moving said recording head and a recording medium relatively to each other along a direction perpendicular to said first direction in a recording operation;
a controller for accepting image data for recording an image by allowing said nozzles of said recording head to discharge an ink and for controlling said recording head and said moving mechanism for recording said image on said recording medium;
an image data converter for converting said image data in such a manner that nozzles used for recording said image are shifted along said first direction in said recording head; and
a position changing means for changing a relative position along said first direction of said recording head against said recording medium in a non-recording operation,
wherein movement of said nozzles of said recording head moved by said position changing means and shift of said nozzles used for recording said image shifted by said image data converter cancel each other.

60. An inkjet recording system comprising:
an inkjet recording head having a plurality of nozzles arranged along a first direction;
moving means for moving said recording head and a recording medium relatively to each other along a second direction not parallel to said first direction;
image data conversion means for converting image data for recording a desired image from a given recording direction in such a manner that said recording direction of said image is changed by rotating said image; and
control means for accepting said converted image data obtained said image data conversion means and controlling said recording head and said moving means for recording said image on said recording medium with said second direction set as a changed recording direction.

61. An inkjet recording system comprising:
an inkjet recording head having a plurality of nozzles arranged along a first direction;
moving means for moving said recording head and a recording medium relatively to each other along a second direction not parallel to said first direction;
image data supply means for supplying image data for recording a desired image from a given recording direction; and
control means for accepting said image data and controlling said recording head and said moving means for recording said image on said recording medium with said second direction set as said recording direction,
wherein said image data supply means converts said image data, after said image is recorded on one or more recording media, in such a manner that said recording direction of said image is changed by rotating said image, and supplies said converted image data.

62. An inkjet recording system comprising:
an inkjet recording head having a plurality of nozzles arranged along a first direction;
moving means for moving said recording head and a recording medium relatively to each other along a second direction not parallel to said first direction in a recording operation;
control means for accepting image data for recording an image by allowing said nozzles of said recording head to discharge an ink and for controlling said recording head and said moving means for recording said image on said recording medium; and
image data conversion means for converting said image data in such a manner that nozzles used for recording said image are shifted along said first direction in said recording head,
wherein said control means accepts said converted image data and controls said recording head for recording said image with nozzles used for the recording shifted along said first direction.

63. An inkjet recording system comprising:
an inkjet recording head having a plurality of nozzles arranged along a first direction;
moving means for moving said recording head and a recording medium relatively to each other along a direction perpendicular to said first direction in a recording operation;
control means for accepting image data for recording an image by allowing said nozzles of said recording head to discharge an ink and for controlling said recording head and said moving means for recording said image on said recording medium;
image data conversion means for converting said image data in such a manner that nozzles used for recording said image are shifted along said first direction in said recording head; and
position changing means for changing a relative position along said first direction of said recording head against said recording medium in a non-recording operation,
wherein movement of said nozzles of said recording head moved by said position changing means and shift of said nozzles used for recording said image shifted by said image data conversion means cancel each other.

64. An inkjet recording system comprising:
an inkjet recording head having a plurality of nozzles arranged along a first direction;
a motor for driving said recording head and said recording medium relatively to each other along a second direction not parallel to said first direction;
an image data converter for converting image data for recording a desired image from a given recording direction in such a manner that said recording direction of said image is changed by rotating said image; and
a controller for accepting said converted image data obtained said image data converter and controlling said recording head and said motor for recording said image on said recording medium with said second direction set as a changed recording direction.

65. An inkjet recording system comprising:
an inkjet recording head having a plurality of nozzles arranged along a first direction;
a motor for driving said recording head and said recording medium relatively to each other along a second direction not parallel to said first direction;
an image data supplier for supplying image data for recording a desired image from a given recording direction; and
a controller for accepting said image data and controlling said recording head and said motor for recording said image on said recording medium with said second direction set as said recording direction,
wherein said image data supplier converts said image data, after said image is recorded on one or more recording media, in such a manner that said recording direction of said image is changed by rotating said image, and supplies said converted image data.

66. An inkjet recording system comprising:
an inkjet recording head having a plurality of nozzles arranged along a first direction;
a motor for driving said recording head and said recording medium relatively to each other along a second direction not parallel to said first direction in a recording operation;
a controller for accepting image data for recording an image by allowing said nozzles of said recording head to discharge an ink and for controlling said recording head and said motor for recording said image on said recording medium; and
an image data converter for converting said image data in such a manner that nozzles used for recording said image are shifted along said first direction in said recording head.

67. An inkjet recording system comprising:
an inkjet recording head having a plurality of nozzles arranged along a first direction;
a motor for driving said recording head and a recording medium relatively to each other along a direction perpendicular to said first direction in a recording operation;
a controller for accepting image data for recording an image by allowing said nozzles of said recording head to discharge an ink and for controlling said recording head and said moving mechanism for recording said image on said recording medium;
an image data converter for converting said image data in such a manner that nozzles used for recording said image are shifted along said first direction in said recording head; and
a position changing means for changing a relative position along said first direction of said recording head against said recording medium in a non-recording operation,
wherein movement of said nozzles of said recording head moved by said position changing means and shift of said nozzles used for recording said image shifted by said image data converter cancel each other.

68. An inkjet recording method comprising:
a recording step of moving a recording head having a plurality of nozzles arranged along a first direction and a recording medium relatively to each other along a second direction not parallel to said first direction, and recording an image on said recording medium from said second direction by using said recording head; and
an image data converting step of converting image data for recording said image from a given recording direction in such a manner that said recording direction of said image is changed by rotating said image,
wherein, in the recording step, an image resulting from change of the recording direction is recorded on said recording medium by using said recording head with said second direction set as said changed recording direction on the basis of said converted image data.

69. The inkjet recording method of claim 68,
wherein said image data is data for recording, from a given linear direction, a complex image in which N (wherein N is a natural number of 2 or more) images identical to one another are repeatedly arranged along said linear direction,
in the image data converting step, said complex image is changed by rotating at least one image out of said images included in said complex image for making a recording direction of said at least one image different from a recording direction of at least one of the other images, and said image data is converted into image data for recording said changed complex image from said linear direction, and
in the recording step, images included in said changed complex image are recorded on said recording medium by using said recording head with said second direction set as said linearly direction on the basis of said converted image data.

70. The inkjet recording method of claim 69,
wherein said recording medium is N in number and said N recording media are arranged along said second direction, and
in the recording step, said images included in said changed complex image are recorded on each of said recording media with said second direction set as said linear direction on the basis of said converted image data.

71. An inkjet recording method comprising:
a recording step of moving an inkjet recording head having a plurality of nozzles arranged along a first direction and a recording medium relatively to each other along a second direction not parallel to said first direction and recording, on the basis of image data for recording a given image from a given recording direction, said image on said recording medium from said second direction by using said recording head; and
an image data converting step of converting said image data, after recording said image once or more times, in such a manner that said recording direction of said image is changed by rotating said image,
wherein, in the recording step, an image resulting from change of said recording direction is recorded on said recording medium by using said recording head with said second direction set as said changed recording direction on the basis of said converted image data.

72. The inkjet recording method of claim 71,
wherein said image data is data for recording, from a given linear direction, a complex image in which N (wherein N is a natural number of 2 or more) images identical to one another are repeatedly arranged along said linear direction,
in the image data converting step, after recording said complex image once or more times, said complex image is changed by rotating at least one image out of said images included in said complex image for making a recording direction of said at least one image different from a recording direction of at least one of the other images, said image data is converted into image data for recording said changed complex image from said linear direction, and
in the recording step, images included in said changed complex image are recorded on said recording medium by using said recording head with said second direction set as said linearly direction on the basis of said converted image data.

73. The inkjet recording method of claim 72,
wherein said recording medium is N in number and said N recording media are arranged along said second direction, and
in the recording step, said images included in said changed complex image are recorded on each of said recording media with said second direction set as said linear direction on the basis of said converted image data.

74. An inkjet recording method comprising:
a recording step of moving an inkjet recording head having a plurality of nozzles arranged along a first direction and a recording medium relatively to each other along a second direction not parallel to said first direction and recording, on the basis of image data for recording a given image, said image on said recording medium by using said recording head by allowing said nozzles of said recording head to discharge an ink; and
an image data converting step of converting said image data in such a manner that nozzles used for recording said image are shifted along said first direction in said recording head,
wherein, in the recording step, said image is recorded by using said recording head with used nozzles shifted along said first direction on the basis of said converted image data after converting said image data in the image data converting step.

75. The inkjet recording method of claim 74, further comprising a position changing step of changing a relative position along said first direction of said recording head against said recording medium by a given distance,
wherein, in the image data converting step, said image data is converted in such a manner that said image is shifted along a direction opposite to a direction of the relative movement of said recording head by a distance equal to said given distance.

76. The inkjet recording method of claim 74,
wherein, in the image data converting step, said image data is converted in such a manner that said image is shifted along said first direction and is rotated.
